(19) United States
(12) Patent Application Publication
(10) Pub. No.: US 2024/0114828 A1
(43) Pub. Date: Apr. 11, 2024

(54) MOW DECK AND BAGGING SYSTEM FOR HIGH EFFICIENCY WALK-BEHIND MOWING APPARATUS

(71) Applicant: MTD PRODUCTS INC, Valley City, OH (US)

(72) Inventors: Daniel S. Zehentbauer, Westlake, OH (US); Christian P. Emhoff, Medina, OH (US); Justin J. Chae, Strongsville, OH (US); Christopher M. Wertenberger, Akron, OH (US); Anthony A. Harrison, Spencer, OH (US)

(21) Appl. No.: 18/373,712

(22) Filed: Sep. 27, 2023

Related U.S. Application Data
(60) Provisional application No. 63/410,328, filed on Sep. 27, 2022.
(60) Provisional application No. 63/429,536, filed on Dec. 1, 2022.

(51) Int. Cl. A01D 34/71; A01D 34/685

(52) U.S. Cl. CPC A01D 34/71; A01D 34/685; A01D 34/78

(57) ABSTRACT

A high efficiency turf maintenance apparatus having low power consumption and good cutting performance is presented herein. A blade configuration is disclosed to provide lift and to propel turf clippings from within a mow deck through a discharge opening therein. A discharge body can receive turf clippings at an input and direct the turf clippings to an output. A bagging apparatus can be coupled to the discharge body output for a bagging mode, a side-rear diverter can be coupled to the discharge body output for a discharge mode, and a mulching plug can cover the discharge body output for a mulching mode.

### CROSS-REFERENCE TO RELATED APPLICATIONS

This application claims the benefit of U.S. Provisional Patent Application No. 63/410,328 filed Sep. 27, 2022; and this application claims the benefit of U.S. Provisional Patent Application No. 63/429,536 filed Dec. 1, 2022, both of which are hereby incorporated in their respective entireties. Also, the following are hereby incorporated by reference within the present disclosure in their respective entireties and for all purposes: U.S. patent application Ser. No. 17/700,255 filed Mar. 21, 2022 and titled BAGGING APPARATUS FOR HIGH-EFFICIENCY LAWN MAINTENANCE TOOL; U.S. Provisional Patent Application No. 63/163,386 filed Mar. 19, 2021, U.S. Pat. No. 10,212,880 issued Feb. 26, 2019 and titled HIGH EFFICIENCY CUTTING SYSTEM; U.S. Provisional Patent Application No. 63/214,547 filed Jun. 24, 2021 titled FOLDABLE HANDLES FOR HIGH-EFFICIENCY TURF MAINTENANCE TOOL.

### FIELD OF DISCLOSURE

The disclosed subject matter pertains to an electric-powered walk-behind power equipment device with a mow deck and cutting system that enhances cutting efficiency and reduces power consumption for the power equipment device.

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Modern maintenance machines also offer multiple options for power source. The various advantages associated with electric motor engines, gasoline engines, natural gas engines, diesel engines and so forth also impact the mechanical design and engineering that go into these different maintenance devices. Meeting the various challenges associated with different maintenance and mowing applications and the benefits and limitations of different power sources results in a large variety of maintenance machines to meet consumer preferences.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure provide a high efficiency turf maintenance apparatus having low power consumption and good cutting performance even in thick turf. A bagging apparatus is provided in various embodiments to collect turf clippings. A blade configuration is disclosed to cut vegetation at a defined height and propel turf clippings from within a mow deck to the bagging apparatus. In some embodiments, the blade configuration can be implemented with minimal impact on power consumption, allowing the bagging apparatus to be utilized with an electric motor power source with little or no impact on battery life. In other embodiments, a blade configuration adapted for improved turf ejection and optimal bagging can be provided. Latter embodiments can incorporate a lift blade within the blade configuration that increases air flow, lift or both of turf clippings within a mow deck, or the blade configuration can be driven at larger rotation per minute (RPM), or the like, or a suitable combination of the foregoing can be provided for a disclosed turf maintenance apparatus.

In one or more aspects of disclosed embodiments, disclosed is a grass mowing apparatus. The grass mowing apparatus can comprise a plurality of front wheels and a plurality of rear wheels, a mow deck and a blade apparatus secured to the mow deck and secured to a plurality of blades. Moreover, the blade apparatus can be configured to drive motion of the plurality of blades within an interior of the mow deck in response to a force applied to the blade apparatus and the plurality of blades comprising more than two blades. Further, the grass mowing apparatus can comprise an electric motor coupled to the blade apparatus and configured to supply the force to the blade apparatus, and a rechargeable battery for providing electrical power to the electric motor. Additionally, the grass mowing apparatus can comprise a discharge opening defined in a side-rear portion of the mow deck, wherein the discharge opening has a leading edge behind a right-most side of the mow deck and a trailing edge near a rear-most side of the mow deck. Still further, the grass mowing apparatus can comprise a discharge chute body having a discharge chute input and a discharge chute output, wherein the discharge chute input of the discharge chute body is fluidly coupled with the discharge opening defined in the mow deck such that air and clippings within an interior of the mow deck enter the discharge chute body from the discharge opening and the discharge chute input and exit the discharge chute body through the discharge chute output.

In another disclosed embodiment, provided is a mow deck for a walk-behind power equipment device. The mow deck can comprise a front portion, a rear portion and a side portion of the mow deck and can comprise a plurality of frame mounts at the rear portion of the mow deck for securing the mow deck to a frame and to a discharge body of a walk-behind power equipment device. In one or more aspects, the mow deck can comprise a center portion defining an opening through a surface of the mow deck and having a seat to support a blade apparatus and an electric motor and one or more mounts to secure the blade apparatus and the electric motor to the mow deck and can comprise a discharge opening defining a second opening through the surface of the mow deck near a perimeter of the mow deck and between the rear portion and the side portion and wherein the discharge opening fluidly couples to a discharge body input of the discharge body of the walk-behind power equipment device. Further, the mow deck can comprise a turf guide structure extending from the side portion toward the front portion and defining a front-facing surface having a first edge that extends approximately to a full extent of the side portion. Still further, the mow deck can comprise a second turf guide structure extending from a second side portion, on an opposite side of the mow deck from the side portion, toward the front portion and defining a second front-facing surface having a second edge that extends approximately to a full extent of the second side portion, wherein a distance across the front portion of the mow deck from the first edge to the second edge is approximately equal to a full width of the mow deck.

Various embodiments of the present disclosure provide a high efficiency turf maintenance apparatus having low power consumption and good cutting performance. Aspects of the disclosed embodiments provide a mow deck interior facilitating improved dispersion of turf clippings from within the mow deck, mitigating or avoiding clumping of turf clippings ejected from the mow deck. In some aspects, an interior height of the mow deck can be elevated at a discharge side thereof to enhance flow of clippings to a discharge chute of the mow deck. When inserted into the discharge chute, a mulch plug interior surface can distribute the turf clippings along the rear of the mow deck to distribute the turf clippings across the rear of the mow deck. Additionally, a rear surface of the mow deck can be provided that promotes increased uniformity of the distribution of turf clippings from the mow deck, in further aspects of the disclosed embodiments.

One or more aspects of the disclosed embodiments provide a grass mowing apparatus. The grass mowing apparatus can comprise a plurality of front wheels and a plurality of rear wheels, and a mow deck comprising a rear interior surface having an asymmetric length portion or an asymmetric height portion with respect to a centerline of the mow deck. Further, the grass mowing apparatus can comprise a cutting system comprising a plurality of blades rotatable within an interior of the mow deck in response to a force. Still further, the grass mowing apparatus can comprise an electric motor coupled to the cutting system and configured to supply the force to rotate the plurality of blades, and a rechargeable battery for providing electrical power to the electric motor. In addition to the foregoing, the grass mowing apparatus can comprise a discharge opening defined in a side-rear portion of the mow deck, wherein the discharge opening has a leading edge behind a right-most side of the mow deck and a trailing edge near a rear-most side of the mow deck, the right-most side and the rear-most side defined relative to an operator position at a rear of the grass mowing apparatus. In one or more additional aspects of the disclosed embodiments, the grass mowing apparatus can comprise a discharge chute body having a discharge chute input fluidly coupled with the discharge opening defined in the mow deck, and a mulching plug configured to fit conformally within the discharge chute input and having a mulching plug interior surface configured to prevent turf clippings from entering the discharge chute body through the discharge opening.

According to further embodiments of the present disclosure, provided is a mulching plug for a discharge chute of a walk-behind power equipment device. The mulching plug can comprise an interior surface having a surface edge that fits conformally with a perimeter of a discharge opening in a mow deck of the walk-behind power equipment device, and an exterior surface that includes an operator handle, wherein the discharge chute defines an intake opening within the discharge body positioned adjacent to the discharge opening in the mow deck. In further aspects, the mulching plug can comprise a discharge extension surface extending from an edge of the exterior surface and that fits conformally with a surface of the discharge chute and has a length dimension approximately equal to a depth of the discharge chute through the discharge body. Moreover, the mulching plug can comprise a sleeve surface at an opposite end of the bottom surface from the exterior surface that seats upon a back surface of the discharge body and prevents the interior surface of the mulching plug from extending through the discharge opening in the mow deck.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 provides an example electric-powered walk-behind outdoor maintenance apparatus according to one or more aspects of the present disclosure.

FIG. 1A illustrates an example electric-powered walk-behind maintenance apparatus with discharge chute and bagging apparatus according to further embodiments.

FIG. 2 illustrates a top-down view of an example high efficiency walk-behind mowing device according to further aspects of the disclosure.

FIG. 3 depicts a top-down view of an example mow deck for the example high efficiency walk-behind mowing device in still further aspects.

FIG. 4 illustrates a top-perspective view of the example mow deck of FIG. 3 showing further aspects of the disclosure.

FIG. 5 depicts a bottom view of the example mow deck of FIG. 3 in still additional aspects of the disclosure.

FIG. 6 depicts a bottom-perspective view of the example mow deck including an example cutting system for cutting vegetation.

FIGS. 7A and 7B illustrate side views of an example mow deck and cutting system according to one or more additional aspects of the present disclosure.

FIGS. 7C and 7D depict close-up views of a front portion and a rear portion, respectively, of the example mow deck according to still further aspects of the present disclosure.

FIG. 8 illustrates a bottom-perspective view of an example mow deck of a walk-behind maintenance device according to still additional aspects of the present disclosure.

FIG. 9 depicts a top-perspective view of a sample mow deck and discharge output plug according to further disclosed aspects.

FIG. 10 provides an image of a discharge output plug in aspects of various embodiments of the present disclosure.

FIG. 11 depicts an image of a rear view of a discharge chute body of an example outdoor maintenance apparatus in still further aspects.

FIG. 12 illustrates a further image of the rear view of the discharge chute body of the example outdoor maintenance apparatus.

FIG. 13 depicts an image of a discharge chute coupled to the discharge chute body of the example outdoor maintenance apparatus, in further embodiments.

FIG. 14 illustrates a bottom view of a discharge chute and mow deck of an example outdoor maintenance apparatus in an aspect of disclosed embodiments.

FIG. 15 depicts example geometric relationships of an example discharge chute according to one or more aspects of the disclosure.

FIG. 15A illustrates example dimensions of the discharge chute of FIG. 15 according to one or more aspects disclosed herein.

FIG. 16 illustrates an underside of a mow deck of the electric-powered walk-behind maintenance apparatus according to further embodiments.

FIG. 17 depicts a close-up view of a rear baffle attachment facilitating uniform distribution of turf clippings from the mow deck, in further aspects of the disclosure.

FIG. 18 illustrates a mow deck rear surface shaped according to the rear baffle attachment facilitating uniform distribution of turf clippings in another embodiment(s).

FIG. 19 depicts a side-perspective view of the rear surface of the mow deck according to further embodiments.

FIG. 20 depicts a minimum blade displacement of the rear surface of the mow deck in additional embodiments.

FIG. 21 depicts a side-perspective view of the minimum blade displacement of the rear surface of the mow deck.

FIG. 22 illustrates a maximum blade displacement of the rear surface of the mow deck according to further embodiments.

FIG. 23 depicts a side-perspective view of the maximum blade displacement in other disclosed embodiments.

FIG. 24 illustrates an interior surface of a mulch plug for a discharge chute according to one or more additional embodiments of the present disclosure.

FIG. 25 depicts a side-perspective view of the interior surface of the mulch plug in further disclosed aspects.

FIG. 26 depicts a front interior view of the mow deck and mulch plug according to additional embodiments of the present disclosure.

FIG. 27 illustrates a front interior view of the mow deck and turf clipping distribution paths at a discharge side and trim side of the mow deck in other embodiments.

FIG. 28 depicts an example mulching plug for a discharge chute of a disclosed maintenance apparatus, in an aspect(s) of the disclosed embodiments.

FIG. 29 illustrates the example mulching plug of FIG. 9 fitted into a discharge body and discharge opening of a mow deck according to further aspects disclosed herein.

FIG. 30 illustrates respective mow deck heights of the discharge side and trim or mulch side of the mow deck in further aspects of the present disclosure.

FIG. 31 depicts a top-down view of the mow deck and changes in height of the interior of the mow deck, in still additional embodiments.

FIG. 32 is a view of one embodiment of a discharge chute.

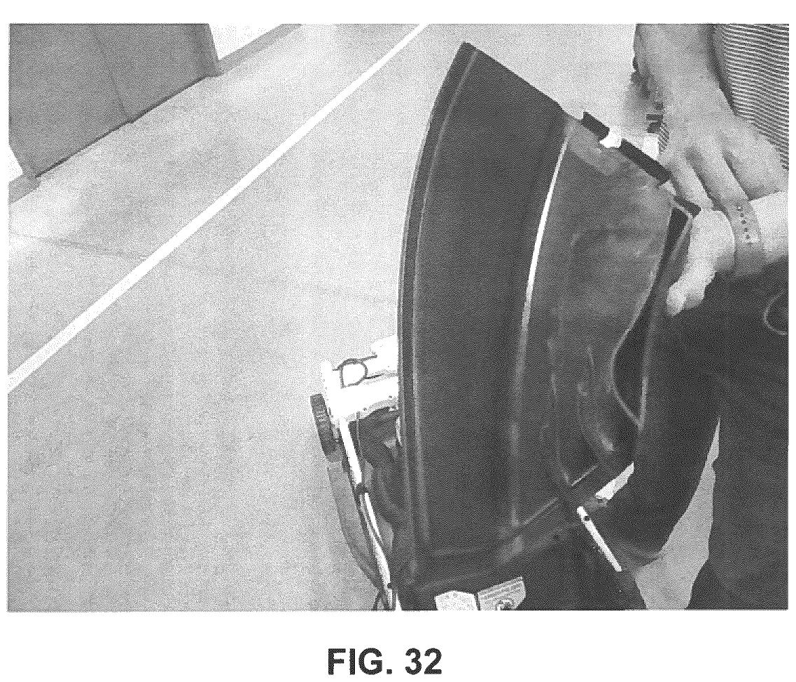

FIG. 33 is an underside of a mow deck of the electric-powered walk-behind maintenance apparatus according to one embodiment.

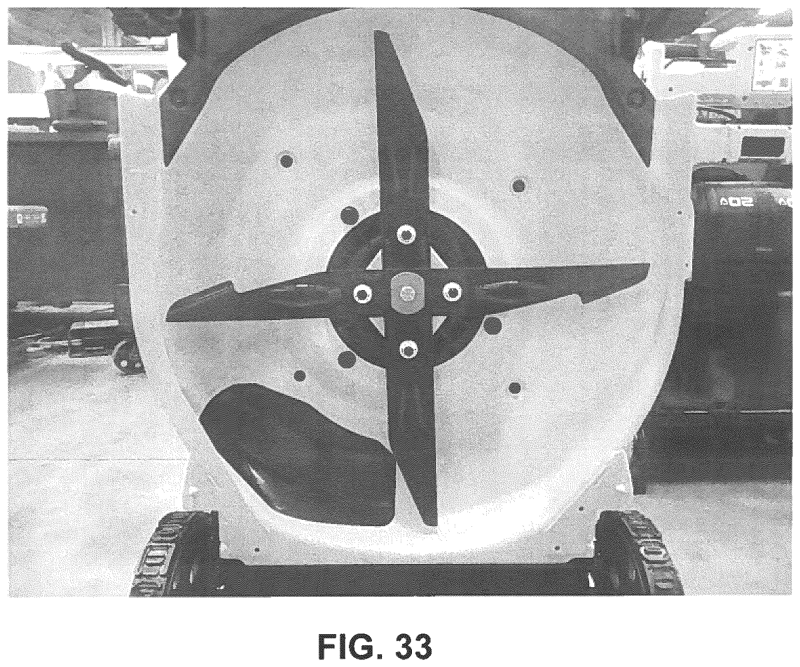

FIG. 34 is a close up view of the underside of the mow deck of FIG. 33.

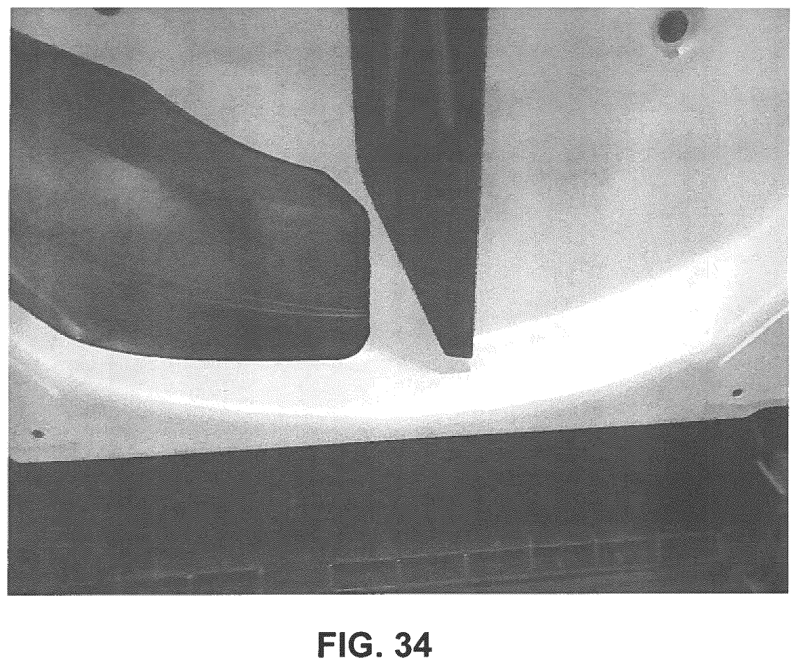

FIG. 35 is another close up view of the underside of the mow deck of FIG. 33.

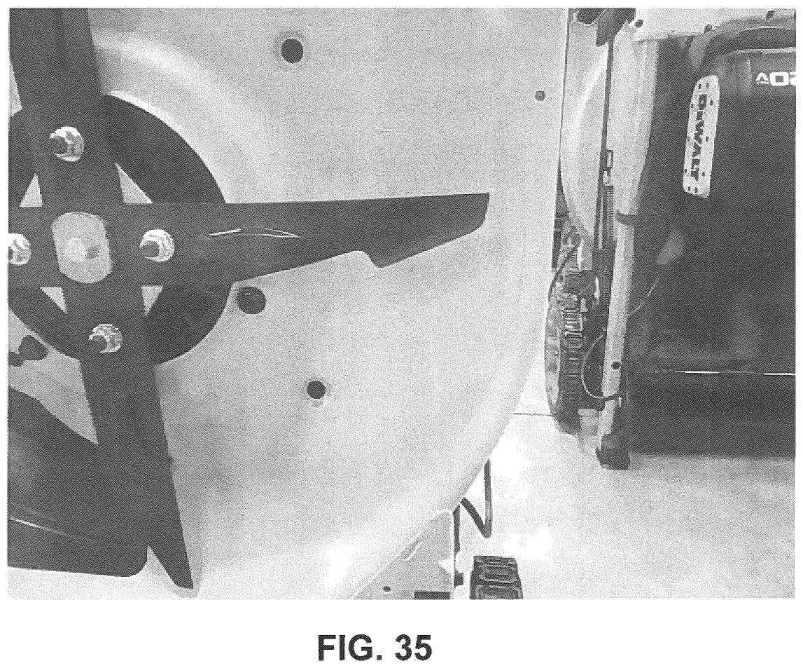

FIG. 36 is the underside of the mow deck of FIG. 33 with the blade assembly in a different orientation.

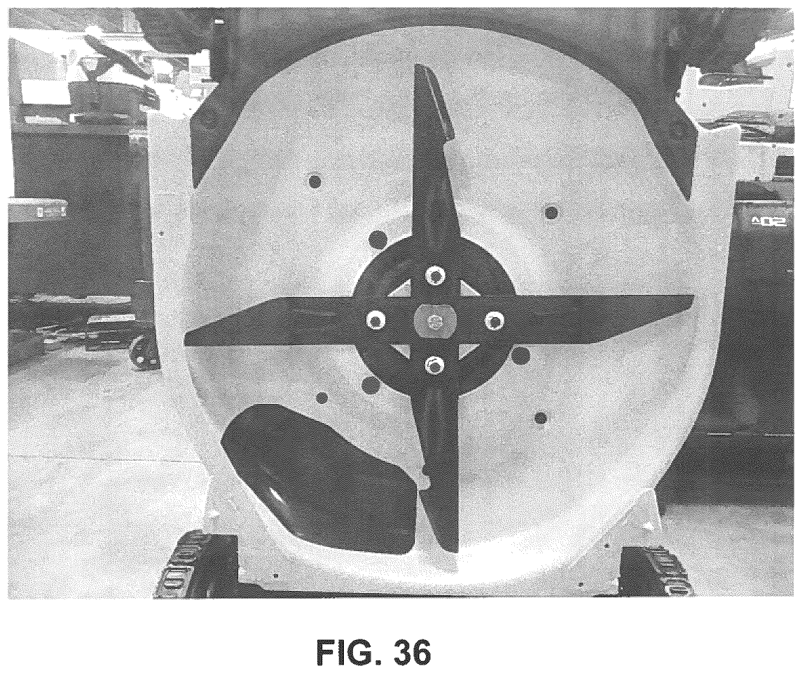

FIG. 37 is a close up view of the underside of the mow deck of FIG. 36.

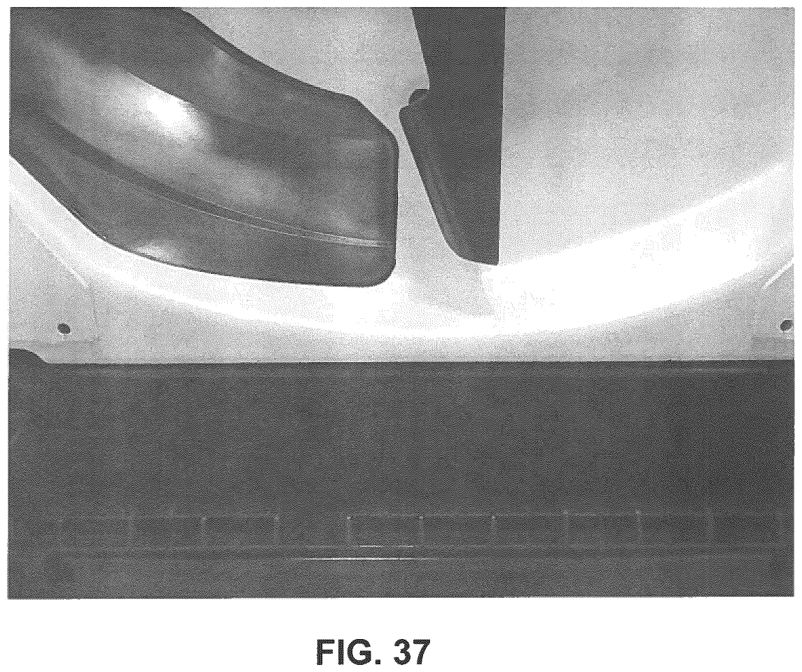

FIG. 38 is another close up view of the underside of the mow deck of FIG. 36.

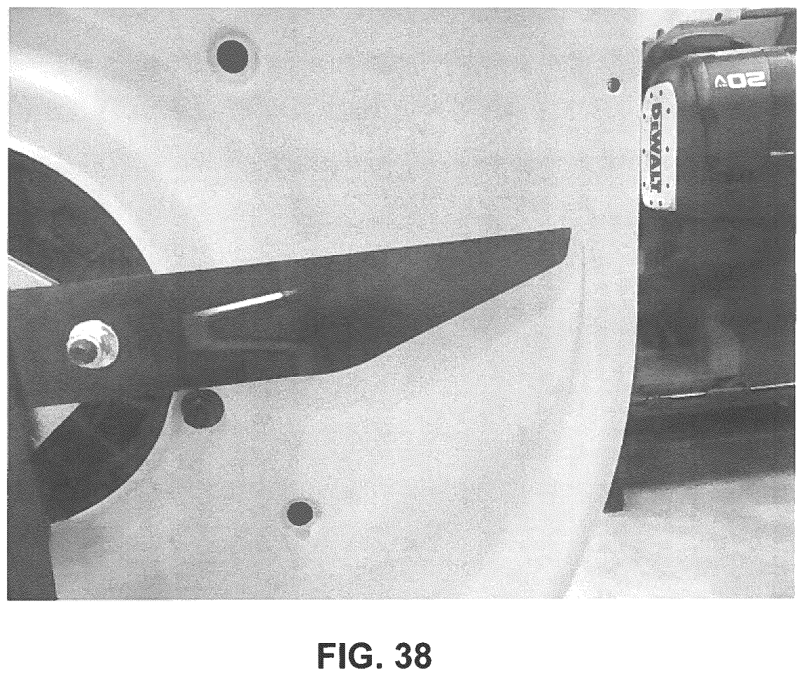

It should be noted that the drawings are diagrammatic and not drawn to scale. Relative dimensions and proportions of parts of the figures have been shown exaggerated or reduced in size for the sake of clarity and convenience in the drawings. The same reference numbers may be used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to high efficiency work housing(s) and discharge components for power equipment machines are described herein, it should be understood that the disclosed machines, components, attachments and the like are not so limited and modifications may be made without departing from the scope of the present disclosure. The scope of the disclosed power equipment machines, components and attachments are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheel barrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

As utilized herein, relative terms or terms of degree such as approximately, substantially or like relative terms such as about, roughly and so forth, are intended to incorporate ranges and variations about a qualified term reasonably encountered by one of ordinary skill in the art in fabricating or compiling the embodiments disclosed herein, where not explicitly specified otherwise. For instance, a relative term can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, relative terminology can refer to a variation in a disclosed value or characteristic, e.g., a 0 to five-percent variance or a zero to ten-percent variance from precise mathematically defined value or characteristic, or any suitable value or range there between can define a scope for a disclosed term of degree. As an example, a walk-behind mower 100 can have an interior dimension of a mow deck: such as a disclosed side wall angle of the mow deck with a variance of 0 to five-percent or 0 to ten-percent; a disclosed mechanical dimension can have a variance of suitable manufacturing tolerances as would be understood by one of ordinary skill in the art, or a variance of a few to several percent about the disclosed mechanical dimension that would also achieve a stated purpose or function of the disclosed mechanical dimension. These or similar variances can be applicable to other contexts in which a term of degree is utilized herein such as relative position of a disclosed element, speed of a disclosed motor in rotations per minute (or other suitable metric), accuracy of measurement of a physical effect (e.g., a relative torque output, a relative electric power consumption, a relative motor speed, etc.) or the like.

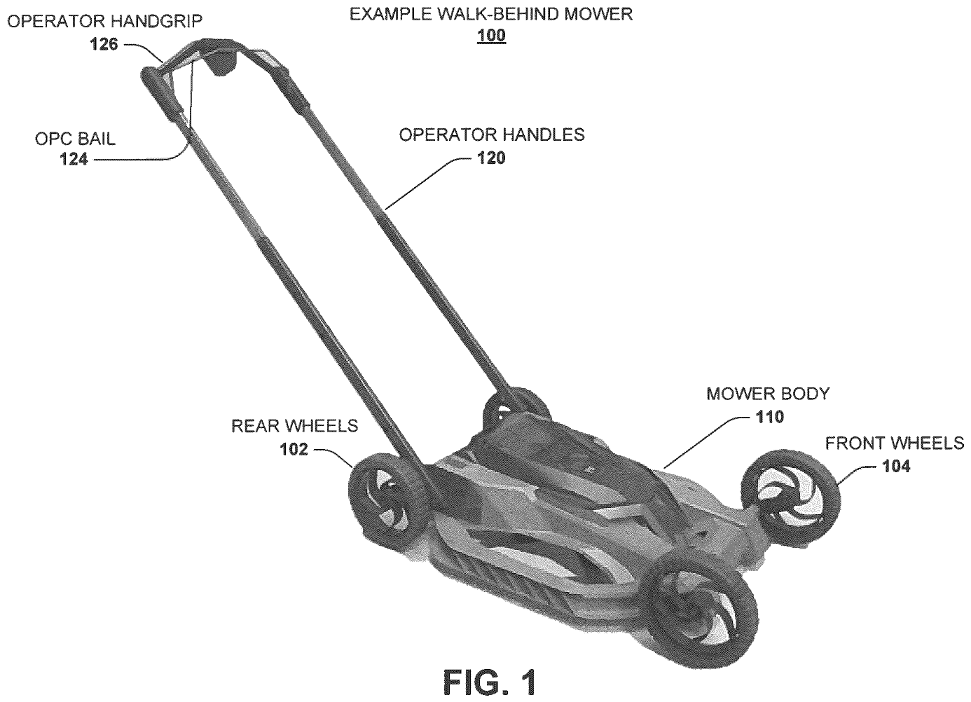

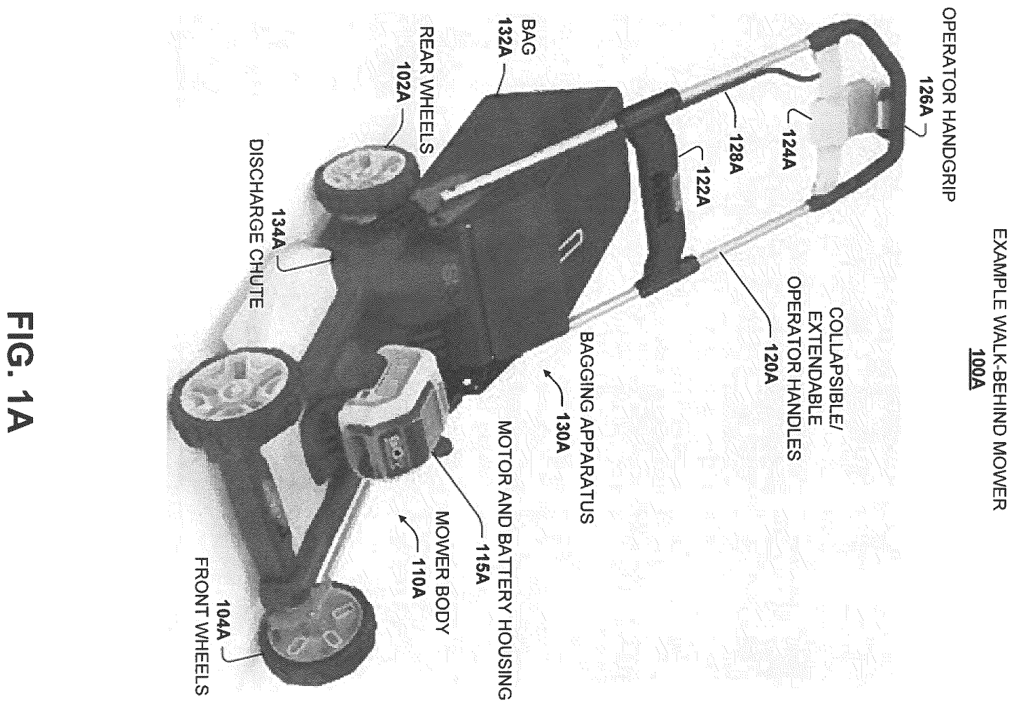

FIG. 1 provides an image of an example walk-behind mower 100 according to aspects of the present disclosure. Walk-behind mower 100 can have a power source to drive an implement of walk-behind mower 100, and in some embodiments to drive rear wheels 102, front wheels 104 or both rear wheels 102 and front wheels 104 of walk-behind mower 100. The power source can be an electric powered lawnmower according to various embodiments, although the subject disclosure is not so limited and in at least some disclosed embodiments a power source of walk-behind mower 100 can be a combustion engine such as a gasoline engine, a natural gas engine, or the like, or can be a hydraulic engine, pneumatic engine, and so forth. In electric powered embodiments, a power source of walk-behind mower 100 can have one or more electric motors for driving a blade apparatus of walk-behind mower 100, and can optionally drive front wheels 104, rear wheels 102 or front and rear wheels 104, 102 to facilitate powered motion of walk-behind mower 100.

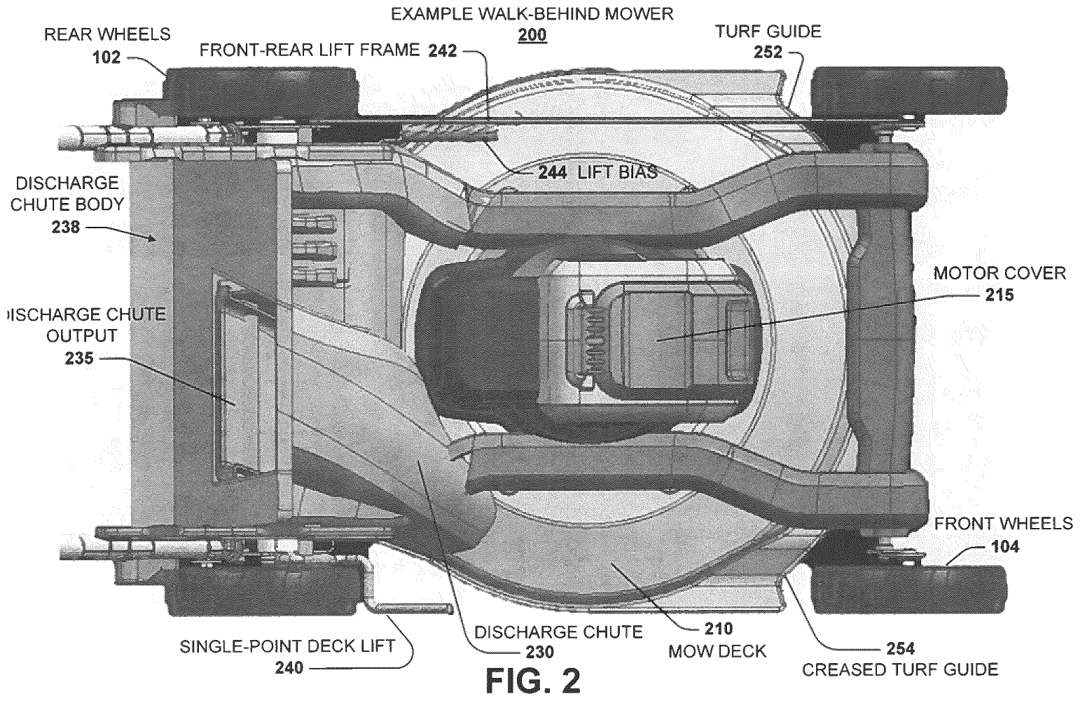

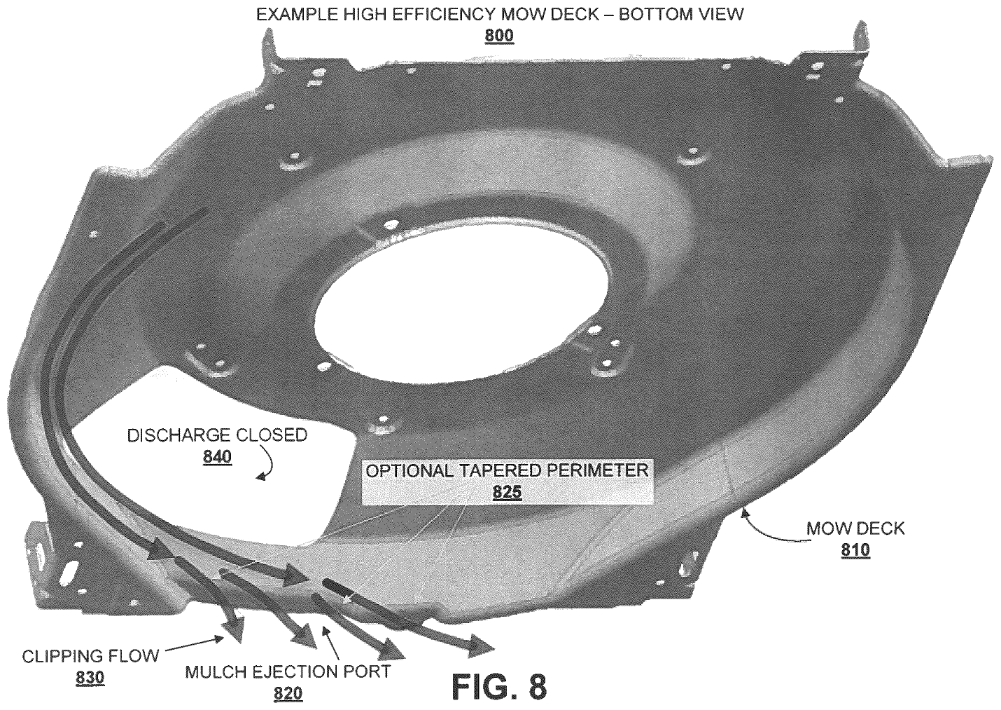

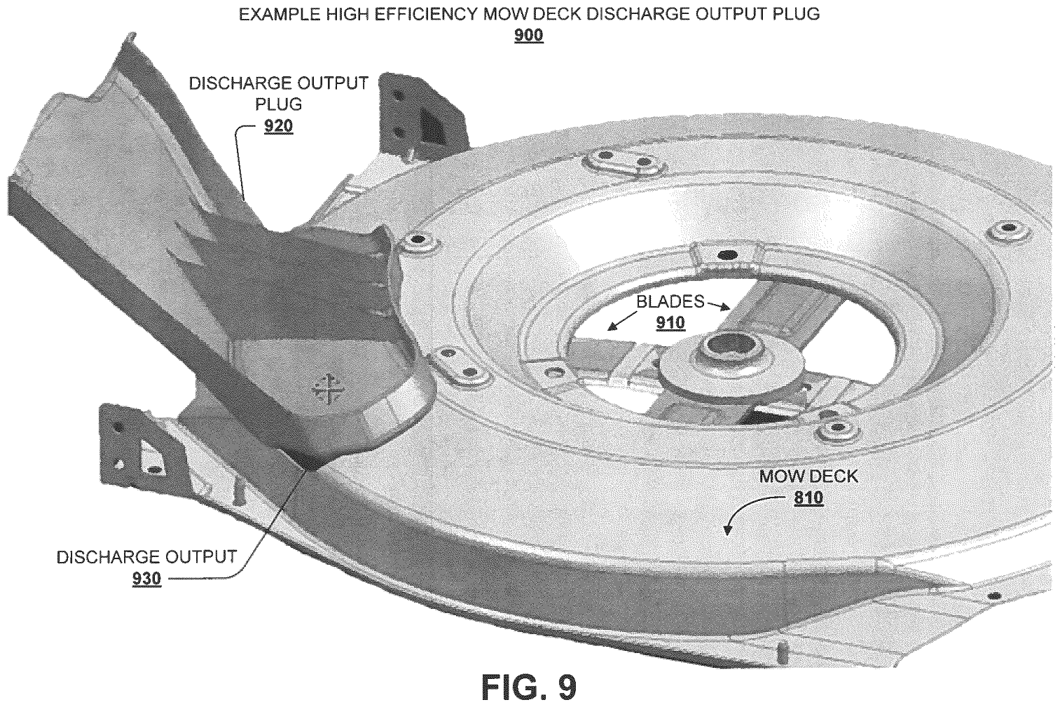

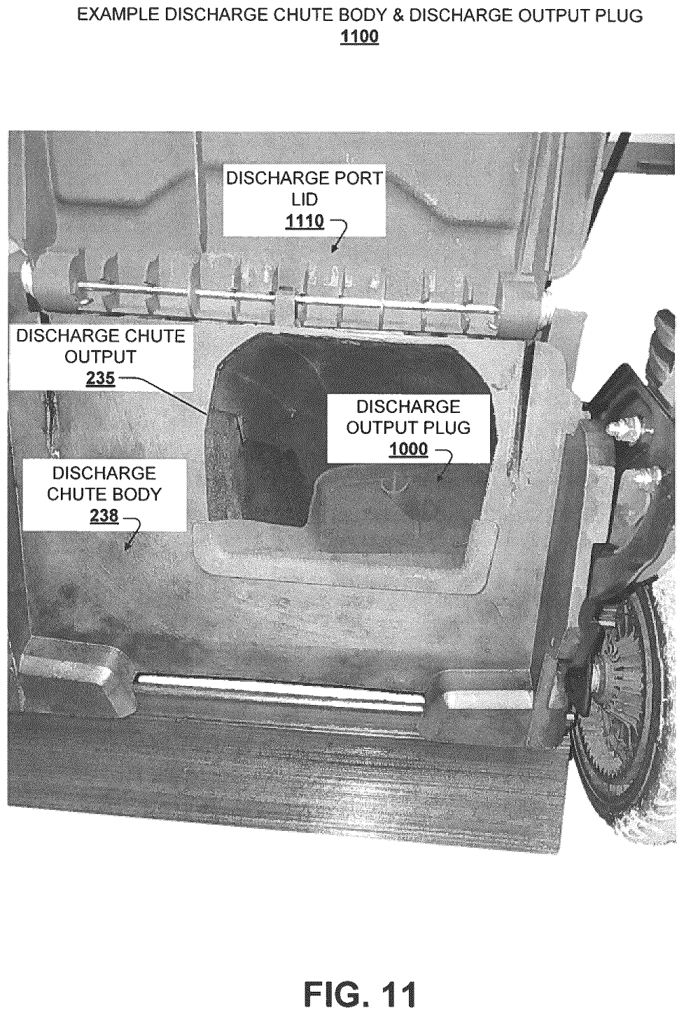

A mower body 110 can house the power source (e.g., engine, motor, etc.), electric batteries in an electric powered lawnmower embodiment(s) and the blade apparatus. An underside of walk-behind mower 110 houses one or more blades for cutting vegetation under the mower body 110. Cuttings from the vegetation—also referred to herein as turf clippings—can be discharged from mower body 110 through a discharge opening (depicted on a right side of mower body 110 in the illustration of FIG. 1, but can be located on different positions of mower body 110 in other embodiments illustrated herein, e.g., see FIGS. 2-6, infra, among others). In some embodiments, a bagging apparatus (not depicted, but see FIG. 1A, infra) can be coupled to the discharge opening to collect turf clippings in a container. In other embodiments, the discharge opening can be closed to prevent discharge of turf clippings through the discharge opening (e.g., see FIGS. 9 and 11, infra, among others). In these latter embodiments, referred to as a mulching operation mode, the turf clippings can be maintained within the underside of mower body 110 and cut multiple times by the blades into small pieces which can fall to the ground under the mower body 110, or be ejected from a mulching ejection port (e.g., see FIG. 8, infra) or being dispersed along a rear of the mower body 110, or some combination thereof.

Walk-behind mower 100 includes a set of operator handles 120 secured to mower body 110 at a first end of operator handles 120. In some embodiments of the present disclosure, operator handles 120 enable an operator to direct or push mower body 110 and front and rear wheels 102, 104, and can be collapsible and extendable to facilitate compact storage when not in use and efficient control over walk-behind mower 100 when in use, respectively (e.g., see U.S. Prov. App. No. 63/214,547 incorporated by reference hereinabove). Operator handles 120 can be configured to lock in a fully collapsed position and to separately lock in a full extended position, in aspects of such embodiments.

At a second end of operator handles 120 is an operator handgrip 126. An operator presence control (OPC) bail cable can be provided and configured to control activation (and deactivation) of a power source of walk-behind mower 100. The OPC bail cable can be coupled to an electric switch that enables or disables electrical power to a power source of walk-behind mower 100 as one example of control over activation and deactivation of the power source. Other examples of activation/deactivation of a power source by an OPC device known in the art or reasonably conveyed to one of ordinary skill in the art by way of the context provided herein are considered to be within the scope of the present disclosure.

FIG. 1A depicts an image of an example walk-behind mower 100A according to further aspects of the present disclosure. Walk-behind mower 100A is shown in a bagging operation mode having a bagging apparatus 130A coupled to a mower body 110A. Mower body 110A includes a mow deck having a discharge opening in a rear-right side orientation of the mow deck (viewed from an operator's perspective, above and behind rear wheels 102A of walk-behind mower 100A). A discharge chute 132A of bagging apparatus 130A is fluidly coupled to the discharge opening of the mow deck and conveys turf clippings output from the discharge opening to a bag 132A, where the turf clippings can be collected.

A motor and battery housing 115A provides a cover for an electric motor(s) secured to mower body 110A, and optionally for a rechargeable battery(ies) providing electrical power to the electric motor(s). Collapsible and extendable operator handles 120A are shown in a fully extended position. An operator handgrip 126A is provided to facilitate operator-control over mower body 110A (including rear wheels 102A and front wheels 104A) to move and direct walk-behind mower 100A. A control cross-member 124A can include an OPC mechanism (not depicted) to control activation/deactivation of the electric motor of walk-behind mower 100A. A signal generated by the OPC mechanism can be conveyed via a connector 128A to a motor controller (not depicted) or to the electric motor to implement the activation/deactivation of the electric motor, in response to a state or condition of the OPC mechanism. Other examples of activation/deactivation of a power source by an OPC device known in the art or reasonably conveyed to one of ordinary skill in the art by way of the context provided herein are considered to be within the scope of the present disclosure. A support cross-member 122A can facilitate collapse of an upper portion of collapsible/extendable operator handles 120A into a lower portion thereof, and vice versa. Support cross-member 122A can also provide enhanced structural support for collapsible/extendable operator handles 120A in the fully extended position as well as in the fully collapsed position.

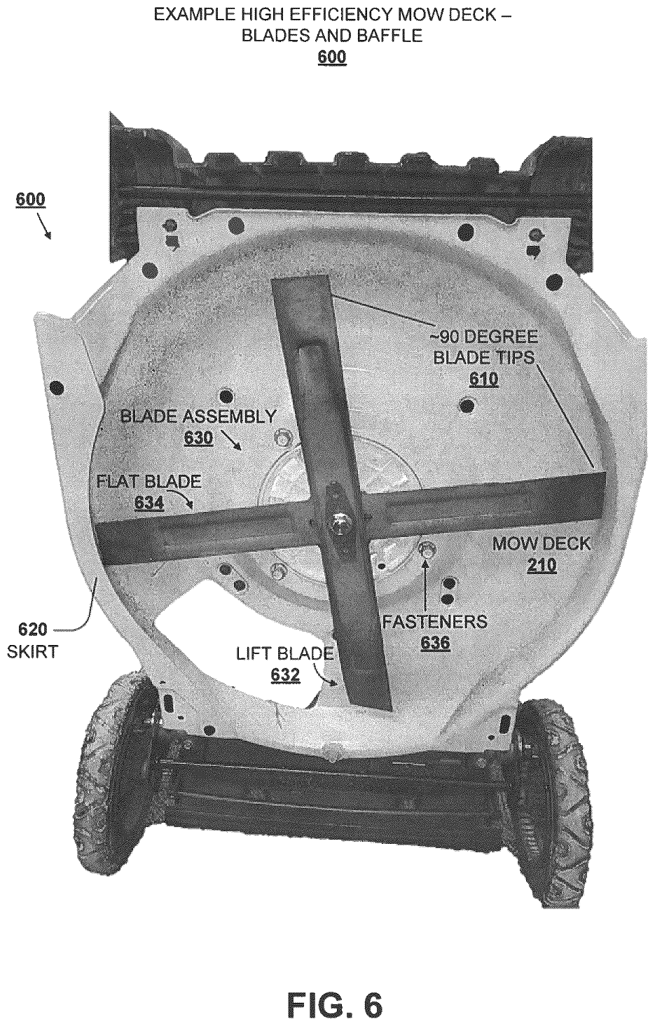

FIG. 2 illustrates an example outdoor maintenance apparatus embodied as a walk-behind, high efficiency (HE) electric mower 200. In some embodiments, HE electric mower 200 can have relatively low power consumption, allowing for only a small to moderate battery size yet a good run time. For instance, with a 21-inch radius mow deck 210 utilizing four cutting blades (not depicted, but see FIG. 6, infra) and an electric motor operating between about 2300 and about 2500 rotations per minute (rpm) in air (e.g., not cutting grass and therefore no friction or mechanical resistance on blade assembly 130 other than air), HE electric mower 200 can consume under 150 watts (W) of power in at least some disclosed embodiments. More importantly, HE electric mower 200 can significantly outperform comparable electric mowers against resistance associated with cutting vegetation. For example, in a proprietary metric of turf difficulty that rates turf cutting resistance as a difficulty percentile, power consumption of HE electric mower 200 can be about 400 W or less for a 20^{th} grass difficulty percentile, whereas comparable electric mowers are well above 600 W at the same 20^{th} grass difficulty percentile. At a 40^{th} grass difficulty percentile, HE electric mower 200 can consume between about 400 and 600 W, whereas the comparable mowers consume about 900 W or higher. Further, at a 60^{th} grass difficulty percentile, HE electric mower 200 can consume about 600 W while the comparable electric mowers consume well over 900 W. The comparison against a common grass difficulty metric demonstrates the significant efficiency of HE electric mower 200, enabling smaller batteries while still achieving longer run times than comparable machines.

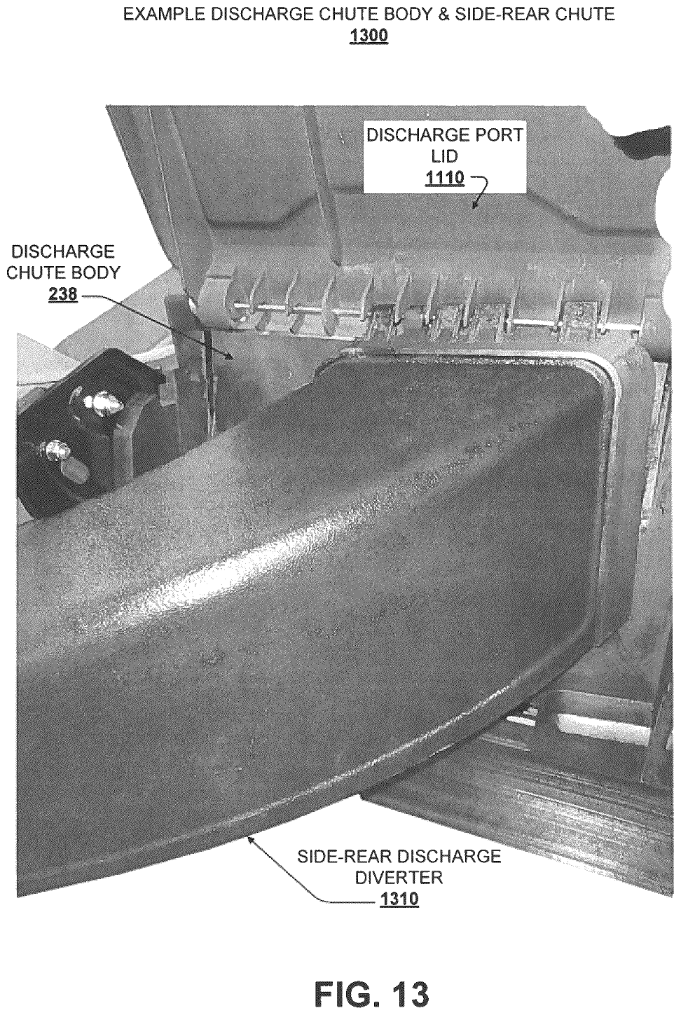

A top-down view of HE electric mower 200 is provided by FIG. 2. HE electric mower 200 includes a mow deck 210 and an electric motor(s), rechargeable battery(ies) and blade apparatus below a motor cover 215. A discharge chute body 238 is coupled to a rear of mow deck 210 and having a discharge chute 230 fluidly coupled to a discharge opening in mow deck 210. Discharge chute body 238 includes a discharge chute output 235 to which a bagging apparatus (e.g., FIG. 1A, supra) or a side-rear diverter (e.g., see FIGS. 13-15, infra) can be coupled. Discharge chute 230 guides turf clippings from mow deck 210 to discharge chute output 235, which can be re-directed by the side-rear diverter or collected by the bagging apparatus. In some embodiments, a discharge chute plug can be inserted into discharge chute output 235 to plug the discharge opening in mow deck 210, to implement a mulching operation mode for HE electric mower 200.

HE electric mower 200 can further include a single-point deck lift 240 for raising and lowering a deck height of HE electric mower 200. A front-rear lift frame 242 member mechanically couples the height of front wheels 104 to a height of rear wheels 102. A lift bias 244 can be coupled to front-rear lift frame 242 to provide mechanical force countering a weight of HE electric mower 200 and reducing a force on single-point deck lift 240 required to raise a height of mow deck 210. Additionally, a left-right lift frame member (not depicted) under (or within) discharge chute body 238 couples a left side of HE electric mower 200 to a height setting established at single-point deck lift 240 on a right side of HE electric mower 200. Accordingly, single-point deck lift 240 allows an operator to raise a deck height of HE electric mower 200 generally from a single actuator.

Mow deck 210 includes one or more creased turf guides 252, 254 formed in a forward portion of mow deck 210. Creased turf guide 252 can extend from a left-most side of mow deck 210 toward a front edge of mow deck 210 and have a front-facing creased surface. Likewise, turf guide 254 can extend from a right-most side of mow deck 210 toward the front edge of mow deck 210 and have a second front-facing creased surface. The front-facing creased surface of creased turf guide 252 is configured to guide grass blades and other vegetation interacting with the front-facing creased surface inward from a perimeter of mow deck 210 to be cut by blades within an underside mow deck 210. This provides a benefit of realizing a full perimeter of mow deck 210 in the cutting of grass/vegetation. Additionally, the crease in the front-facing creased surface can retain the grass blades/vegetation inward from the perimeter of mow deck 210 in thicker grass or vegetation, realizing the full perimeter of mow deck 210 in cutting higher densities or thicknesses of grass/vegetation.

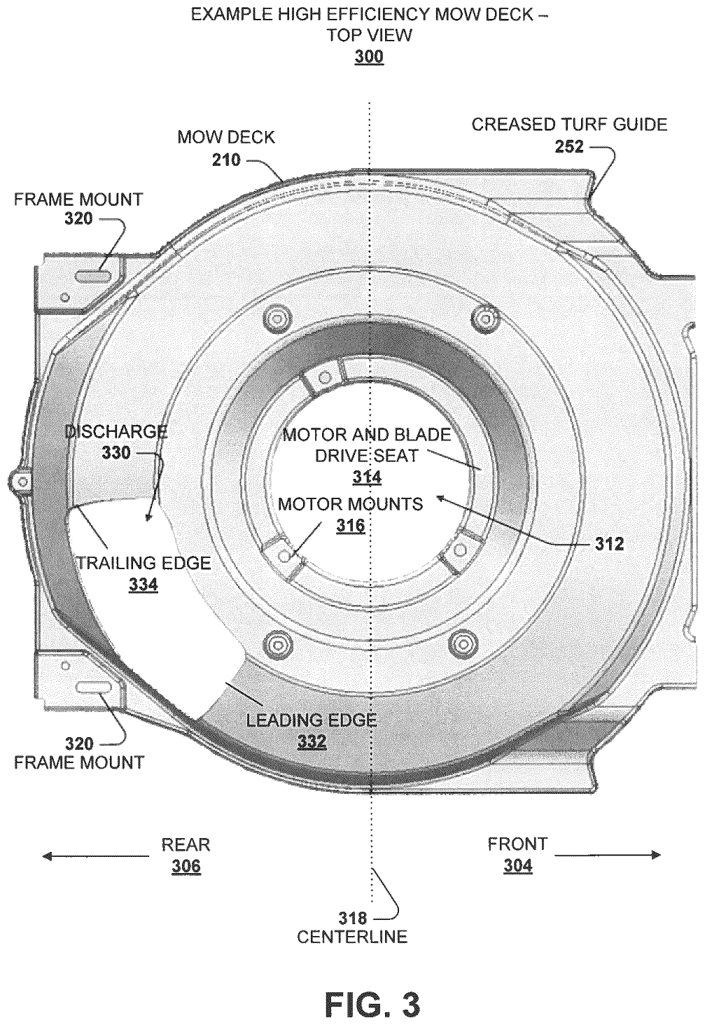

FIG. 3 illustrates a top-down view 300 of a HE mow deck 310, according to further aspects of the present disclosure. In various aspects, HE mow deck 210 as depicted in FIG. 3 can be the same as mow deck 210 of FIG. 2, incorporating additional features and characteristics described below. In at least some aspects, mow deck 210 as depicted in FIG. 3 can at least partly differ from that described elsewhere herein.

As illustrated, HE mow deck 210 is illustrated having a front portion 304 and rear portion 306, as indicated by the respective arrows. HE mow deck 210 includes a central portion 312 that defines an opening through which a blade assembly can be situated. The blade assembly is coupled to a motor drive of an electric motor, and the electric motor and blade assembly can be positioned on motor and blade drive seat 314. A set of motor mounts 316 are provided to secure the electric motor and blade assembly to motor and blade drive seat 314 and HE mow deck 210.

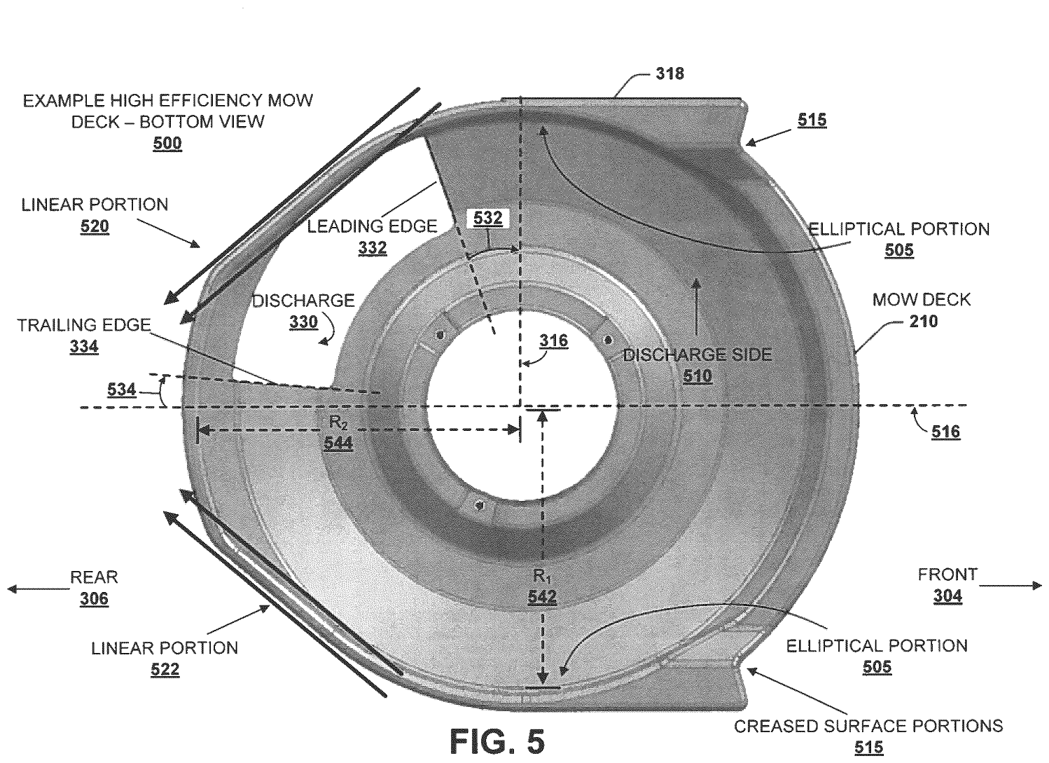

Frame mounts 320 are provided at rear portion 306 of HE mow deck 210 to secure HE mow deck 210 to a frame of a walk-behind mowing apparatus (e.g., 100, 100A, 200, etc.). HE mow deck 210 defines a discharge opening 330 having a leading edge 332 nearest front portion 304 and a trailing edge 334 nearest rear portion 306. In various aspects, leading edge 332 can be behind a centerline 316 through a center of HE mow deck 210 (e.g., see FIG. 5, infra) distinguishing front portion 304 from rear portion 306. In further aspects, trailing edge 334 can be near or forward of a rear-most point on a perimeter of HE mow deck 210. The rear-most point of HE mow deck 210 can be coincident with a line perpendicular to centerline 316 that separates a right side and a left side of HE mow deck 210 (not depicted, but see FIG. 5, infra).

Creased turf guide 252 is illustrated separate from other components of a lawnmower apparatus to which HE mow deck 210 is secured. A geometry of creased turf guide 252 is more visually evident from FIG. 3 as a result. Specifically, creased turf guide 252 is formed integral with HE mow deck 210 as an intrinsic element thereof. In addition, creased turf guide 252 has a front-facing surface (in a direction of the arrow of front portion 304) that is not smooth, but rather has a crease, crimp, or otherwise irregular non-flat surface that encourages grass or other vegetation to lean inward from a (left) perimeter of HE mow deck 210 and resists movement outward from the perimeter of HE mow deck 210. The irregular non-flat surface can restrain thicker or larger quantities of grass blades (or other vegetation) within the perimeter than a smooth front-facing surface by at least in part trapping the grass blades in a creased portion of creased turf guide 252. Creased turf guide 252 can ensure a more uniform cut of vegetation by guiding suitable vegetation within a perimeter of HE mow deck 210 to a path of cutting blades of the blade assembly.

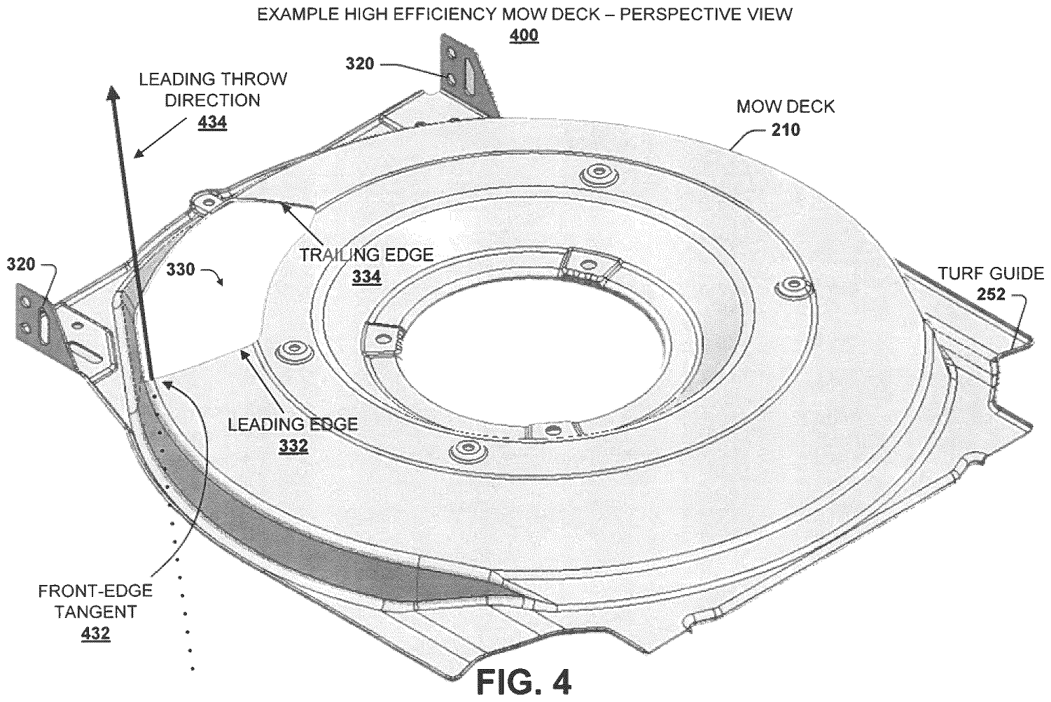

FIG. 4 illustrates a top-perspective view 400 of an example HE mow deck 210 according to alternative or additional aspects of the presently disclosed embodiments. HE mow deck 210 can incorporate other elements described herein or can in part differ from similar aspects disclosed herein, as suitable to one of ordinary skill in the art. Top-perspective view 400 shows a leading edge 332 of discharge opening 330 having a front-edge tangent line 432. Front-edge tangent line is coincident with a point where leading edge 332 intersects (or comes closest to) an outer perimeter of HE mow deck 210, and is tangent to (or approximately tangent to) that outer perimeter. Front-edge tangent line defines a leading throw direction 434 for turf clippings cut by a disclosed electric mower and ejected through the discharge opening 330 of HE mow deck 210. In an embodiment, an orientation of leading edge 332 can be selected such that leading throw direction 432 intersects a back wall of a bag of a bagging apparatus, and optionally left of center of the back wall of the bag (e.g., see bag 132A, bagging apparatus 130A and walk-behind mower 100A of FIG. 1A, supra). This provides several benefits for the bagging apparatus. First, turf clippings directed to the rear of the bag accumulate from the rear to the front. This type of accumulation can mitigate or avoid obstructions (e.g., grass clumps) at a front of the bag that reduce full utilization of an interior of the bag in collecting the turf clippings. Since discharge opening 330 is on a right side of HE mow deck 210, optionally filling the bag from the rear-left first—and forward and to the right from there—can leave an opening at the front-right of the bag coupled to discharge opening 330 last to be filled. This increases a likelihood that when turf clippings accumulate at or near the discharge opening 330, the bag is fully (or near fully) filled to capacity. This increases effective utilization of the interior space of the bag.

In different aspects of the present disclosure, discharge opening 330 can be positioned differently on a top surface of HE mow deck 210. As one example, discharge opening 330 can be positioned on a left-rear position thereof (when viewed from an operator's position behind and above HE mow deck 210). Similarly, a discharge chute of a bagging apparatus can be configured to be coupled with discharge opening 330 on the left-rear position, and a leading edge 332 can be oriented to generate a leading throw direction 434 directed to a rear position of the bag, optionally right of center. This can serve to fill the bag from the right-rear to the front-left. Other suitable spatial orientations known in the art or reasonably conveyed to one of ordinary skill in the art by way of the context provided herein are considered within the scope of the present disclosure.

FIG. 5 depicts a bottom-view 500 of HE mow deck 210, according to still further aspects of the present disclosure. Bottom-view 500 illustrates an inner perimeter of HE mow deck 210, which covers and confines a blade path of cutting blades of a cutting assembly properly positioned with respect to motor and blade drive seat 314 and motor mounts 316, as described above at FIG. 3, supra. The inner perimeter includes an elliptical portion 505 that can extend throughout a front half thereof, in front of centerline 316 (separating front portion 304 from rear portion 306) and partway behind centerline 316. In one aspect, elliptical portion 505 can define a portion of a circle defining a circumference as the inner perimeter, through in other aspects elliptical portion 505 is a non-circular ellipse defining as shape of the inner perimeter.

As illustrated, the inner perimeter of HE mow deck 210 also includes a linear portion 520 or substantially linear portion. In some aspects, linear portion 520 can begin behind leading edge 332 of discharge opening 330. In such aspects, the inner perimeter changes from an elliptical shape of elliptical portion 505 to a linear shape of linear portion 520 within rear portion 306 of HE mow deck 210 at or past leading edge 332. Linear portion 520 can serve as a baffle directing turf clippings out of discharge opening 330 by minimizing a space between discharge opening and the inner perimeter of HE mow deck 210. For instance, linear portion 520 can be coincident with (or substantially coincident with) an edge of discharge opening 330 for at least a segment of linear portion 520. The inner perimeter (and in the illustration of FIG. 5, also an outer perimeter) of HE mow deck 210 intrinsically defines the linear portion 520 serving as the baffle instead of having an extrinsic baffle secured to or formed within the inner perimeter of HE mow deck 210. (In contrast, e.g., with an outer perimeter defined by elliptical portion 505 that extends throughout the exterior of HE mow deck 210 from front portion 304 through rear portion 306 and back).

As illustrated, discharge opening 330 and linear portion 520 is on a discharge side 510 of HE mow deck 210 as defined by a left-right centerline 516. In one or more disclosed aspects, the inner perimeter of HE mow deck 210 can be symmetric about left-right centerline 516 and define a second linear portion 522. A second inner perimeter of HE mow deck 210 can extend from a rearmost edge of linear portion 520 to a rearmost edge of linear portion 522. The second inner perimeter can define a second radius distance R₂ 544 between a rear-most point of the second inner perimeter and a center point of HE mow deck 210 (e.g., at an intersection of centerline 316 and left-right centerline 516). Additionally, the inner perimeter can define a first radius distance R₁ 542 from the center point of HE mow deck 210, as illustrated by dashed lines, to a side-most edge of inner perimeter. The first radius distance R₁ 542 can be less than the second radius distance R₂ 544 in various aspects of the disclosed embodiments. In at least some aspects, the inner perimeter can also define a third radius distance (not depicted) between the center point and a front-most point of the inner perimeter. In at least one aspect, the third radius distance can be the same or substantially the same as the second radius distance R₂ 544, although the subject disclosure is not so limited and the center to front distance can be different from the center to rear distance in other aspects.

According to additional aspects of the present disclosure, a leading edge 332 of discharge opening 330 can be formed at a first angle 532 to centerline 316. In the illustrated aspects, first angle 532 can be an angle greater than zero. In some aspects, first angle 532 can be a range of angles between about zero degrees and about forty degrees (establishing an orientation of leading edge 332 with respect to a front-most edge of HE mow deck 210 intersecting left-right centerline 516 between about ninety degrees and about one hundred thirty degrees). In at least one aspect, first angle 532 can be about twenty degrees (establishing the orientation of leading edge 332 and front-most edge of HE mow deck 210 at about one hundred ten degrees).

A trailing edge 334 of discharge opening 330 can be formed at a second angle 534 to left-right centerline 516. Second angle 534 can be in a range from about zero degrees to about ten degrees, in one or more aspects of the disclosed embodiments. As one example, second angle 534 can be from about 2 to about 7 degrees, or any suitable value or range there between (e.g., about 5 degrees, etc.). Bottom view 500 of HE mow deck 210 also depicts an underside of creased surface portions 515 of creased turf guides 252, 254. The underside of creased surface portions 515 can match the creased front-facing surface described above with respect to FIGS. 2 and 3, guiding grass blades inward from a perimeter of HE mow deck 210 and retaining or trapping the blades at the irregular crease of the creased front-facing surface.

FIG. 6 depicts a bottom view of an underside 600 of a disclosed walk-behind mower comprising HE mow deck 210 according to further aspects of the present disclosure. A blade assembly 630 is depicted secured by fasteners 636 to mow deck 210 at motor mounts 316 as shown in FIG. 3, supra. Blade assembly 630 includes a lift blade structure 632 and a flat blade structure 634. Each blade structure comprises two blades at opposing sides of central portion 312 of HE mow deck 210. Accordingly, lift blade structure 632 defines two lift blades at respective sides of central portion 312 and flat blade structure 634 defines two flat blades at respective sides of central portion 312. Lift blades of lift blade structure 632 generate lift for clippings within HE mow deck 210 that bring the clippings upward within underside 600 of the HE mow deck 210 away from the ground or surface on which the walk-behind mower rests. The lift also effectively pushes clippings that reach the discharge opening 330 upward out of HE mow deck 210. An angle 610 between each of the blades can be about ninety degrees apart. Additionally, HE mow deck 210 can have a baffle 620 (also referred to as a skirt 620) on a discharge side 510 of HE mow deck 210. Skirt 620 can define a surface underlying a path of lift blade structure 632 and flat blade structure 634 that extends inward of an inner perimeter of HE mow deck 210. Skirt 620 can serve to direct turf clippings within underside 600 of HE mow deck 210 out of discharge opening 330 thereof as the turf clippings are moved to the discharge side 510 of HE mow deck 210 by an air vortex caused by rotation of blade assembly 630 (e.g., see FIG. 8, infra). Skirt 620 can be secured to a bottom surface of HE mow deck 210 on the discharge side 510 thereof, or can be formed integral with HE mow deck 210 in at least one aspect of the disclosed embodiments.

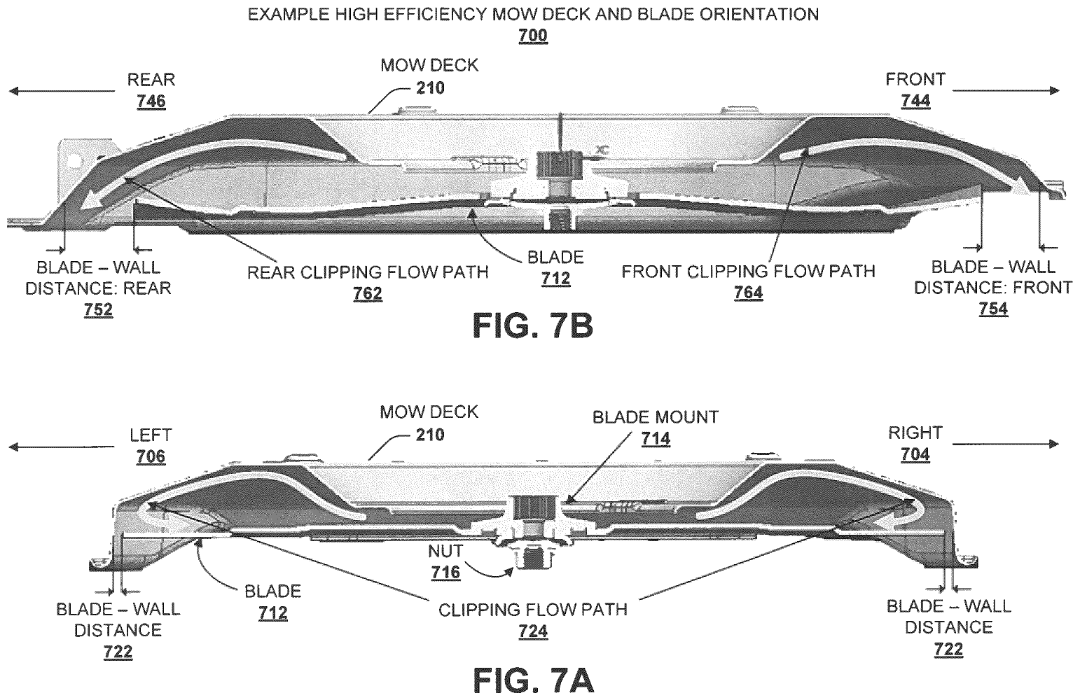

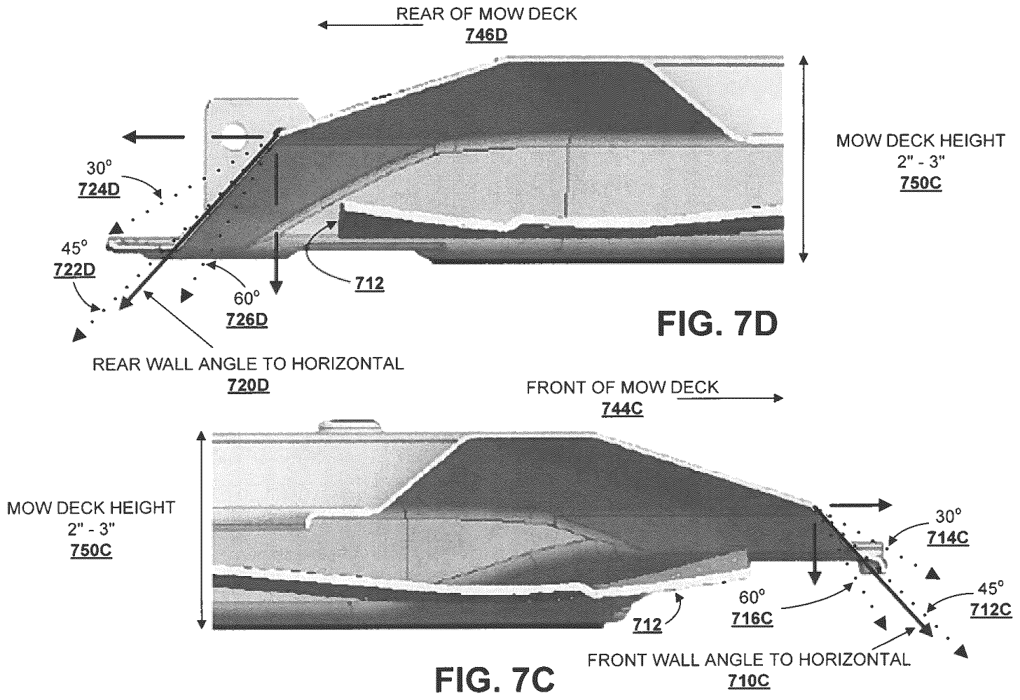

FIGS. 7A and 7B illustrate side views of a HE mow deck 210 and blade assembly 630 from a front-side orientation (illustrated in FIG. 7A) and a right-side orientation (illustrated in FIG. 7B), respectively. Referring initially to FIG. 7A, HE mow deck 210 is depicted having a left side 706 and right side 704, as shown. A blade assembly 630 is secured to a blade mount 714 by a nut 716 in the embodiment illustrated by FIGS. 7A and 7B. A length of a blade 712 of blade assembly 630 defines a blade-wall distance 722 between a furthest length of blade 712 and the inner perimeter of HE mow deck 210. Blade-wall distance 722 can be set to a relatively small length that minimizes the distance between the blade 712 and inner perimeter of HE mow deck 210, resulting in a clipping flow path 724 that directs clippings moving outward to the inner perimeter of HE mow deck 210 back toward an interior of HE mow deck 210 and above blade 712. Clippings within HE mow deck 210 at left and right sides are generally retained above blade 712 and within the interior thereof.

Referring now to FIG. 7B, a front side 744 and rear side 746 of HE mow deck 210 are shown. As illustrated, HE mow deck 210 can have a rear blade—wall distance 752 and front blade—wall distance 754 substantially larger than the left and right side blade—wall distances 722. This causes a rear clipping flow path 762 and front clipping flow path 764 that directs clippings out of HE mow deck 210 (e.g., in a mulching mode operation). At rear blade—wall distance 752 the rear clipping flow path 762 directs turf clippings out of a discharge opening 330 in a rear portion of HE mow deck 210 (e.g., for bagging or side discharge mode operation in which a discharge opening 330 is un-obstructed and a bagging apparatus is coupled to HE mow deck or a discharge chute, respectively). At front side 744 of HE mow deck 210, clippings can be directed downward in front of blade 712 to the ground.

FIG. 7C depicts an enlarged view of HE mow deck 210 at front side 744C and rear side 746D portions thereof. HE mow deck 210 at front side 744C shows a front edge of HE mow deck 210 extending downward in front of a forward extent of blade 712. An angle 710C of the front wall to horizontal is shown at FIG. 7C. Angles 30° 714C and 60° 716C to horizontal are illustrated by dotted lines extending from a top of the front edge of HE mow deck 210. In various aspects, angle 710C of the front wall to horizontal can be between about 30° 714C and about 60° 716C, or any suitable value or range there between. In still further aspects, angle 710C can be about 45° 712C to horizontal, between about 40° and about 55° to horizontal or any suitable value or range there between.

A rear side 746D of HE mow deck 210 at FIG. 7D shows a rear edge thereof extending downward beyond a rear extent of blade 712. An angle 720D of the rear wall to horizontal is shown. Angles 30° 724D and 60° 726D to horizontal are also shown, again by dotted lines, extending from a top of the rear edge of HE mow deck 210. Angle 720D of the rear wall to horizontal can be between about 30° 724D and about 60° 726D in one or more aspects, or any suitable value or range there between. In further aspects, angle 720D can be about 45° 722D to horizontal, between about 40° and about 55° to horizontal, or any suitable value or range there between.

In still further aspects of the present disclosure, HE mow deck 210 can have a height 750C from about 2 inches to about 3 inches. Height 750C can be any suitable value or range there between in additional aspects. Examples include 2.25 inches, 2.5 inches, 2.75 inches, etc.

FIG. 8 illustrates a bottom view 800 of a HE mow deck 810, according to still further embodiments of the present disclosure. HE mow deck 810 can have the same or similar elements as HE mow deck 210 as described throughout this specification. In at least some aspects, HE mow deck 810 can partially differ from HE mow deck 210.

HE mow deck 810 includes a closed discharge opening 840. The discharge opening can be substantially similar to discharge opening 330 of FIG. 3, supra. A discharge opening plug (e.g., see FIGS. 9-11, infra) can be utilized to fill a discharge opening 330 to achieve closed discharge opening 840, in one or more embodiments. Flow of clippings caused by an air vortex within HE mow deck 210 from rotation of a blade assembly is depicted by clipping flow 830. Closed discharge opening 840 can facilitate a mulching operation mode, in which the blade assembly cuts turf clippings multiple times into small pieces. A mulch ejection port 820 can facilitate ejection of clippings from an interior of HE mow deck 810. Mulch ejection port 820 can be positioned in a rear portion 306 of an inner perimeter of HE mow deck 810. For instance, mulch ejection port 820 can be formed from a bottom portion of HE mow deck 810 in the rear portion. In one or more aspects of the disclosed embodiments, mulch ejection port 820 can have an optional tapered perimeter 825 with a non-uniform height. In such optional embodiments, as illustrated, much ejection port 820 can have a larger height at an initial edge where clipping flow 830 first encounters mulch ejection port 820, and a lower height near a far edge of mulch ejection port 820. This can enable a more uniform distribution of clippings ejected out of the mulch ejection port 820 onto the ground, leading to a more aesthetic distribution of mulched clippings, and mitigating or avoiding clumps of clippings. In at least some embodiments, optional tapered perimeter 825 can have a different non-uniform height; for example, the initial edge can have the lower height and the far edge can have the larger height, in various aspects of the disclosed embodiments.

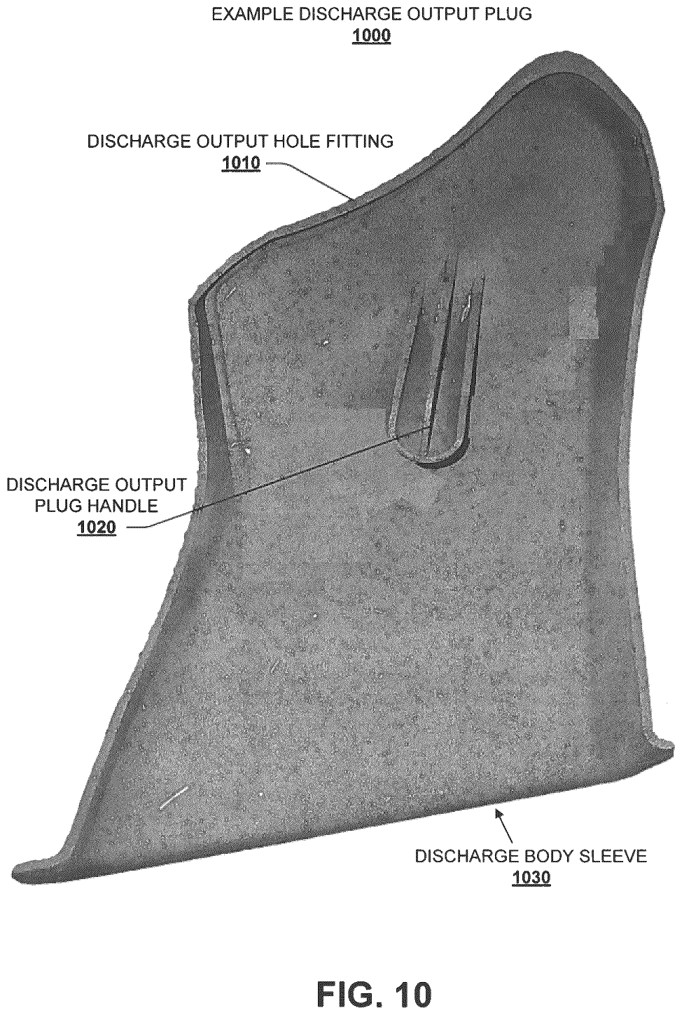

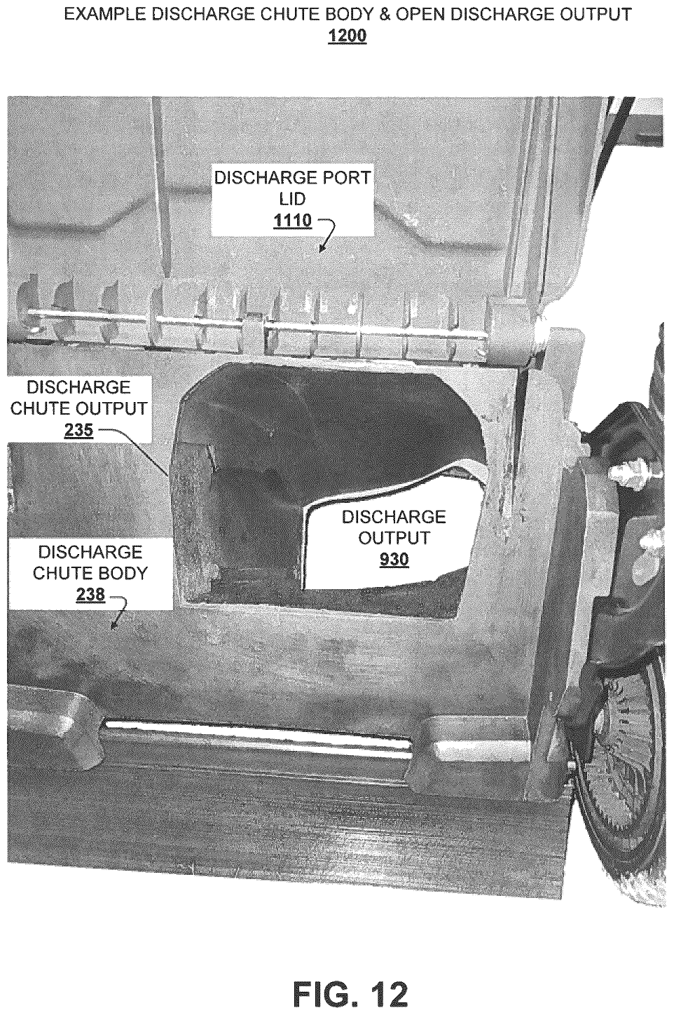

FIG. 9 illustrates a further aspect of a disclosed HE mow deck 810. HE mow deck 810 is depicted as disconnected from a discharge chute body 238, a frame, wheels and other elements of a disclosed walk-behind mower. HE mow deck 810 is depicted with a discharge opening 930 having a discharge output plug 920 inserted therein. Discharge output plug 920 inserted into discharge opening 930 can produce the closed discharge opening 840 discussed with respect to FIG. 8, supra, facilitating the mulching operation mode described herein. FIG. 10 illustrates an example discharge output plug 1000 from a top-down view. Discharge output plug 1000 can include a discharge output plug handle 1020 to enable an operator to position discharge output plug 1000 within a discharge chute output 235 of discharge chute body 238, as illustrated in FIG. 11, to cover discharge output 930. A discharge body sleeve 1030 can have an edge that remains flush to an outside surface of discharge chute body 238, underneath a discharge port lid 1110. Discharge port lid 1110 can be closed over discharge chute output 235 and discharge output plug 1000, and can be lifted off from discharge chute output 235 to access discharge output plug 1000. Discharge body sleeve 1030 can limit a distance within discharge chute output 235 that discharge output plug 1000 can extend. Discharge output plug handle 1020 can facilitate an operator extracting discharge output plug 1000 from discharge chute body 238 as well, to facilitate a bagging operation mode described hereinabove. FIG. 12 depicts an image 1200 of an example walk-behind mower with discharge output plug 1000 removed from under discharge port lid 1110. As shown, removal of discharge output plug 1000 reveals discharge output 930 of HE mow deck 810 through discharge chute output 235 with discharge port lid 1110 lifted. Insertion of a side-rear diverter (e.g., FIGS. 13-15, below) into discharge chute output 235 can enable a side-rear discharge operation mode, whereas insertion of a bagging apparatus over discharge chute output 235 underneath discharge port lid 1110 can facilitate a bagging operation mode (e.g., as shown at FIG. 1A, supra).

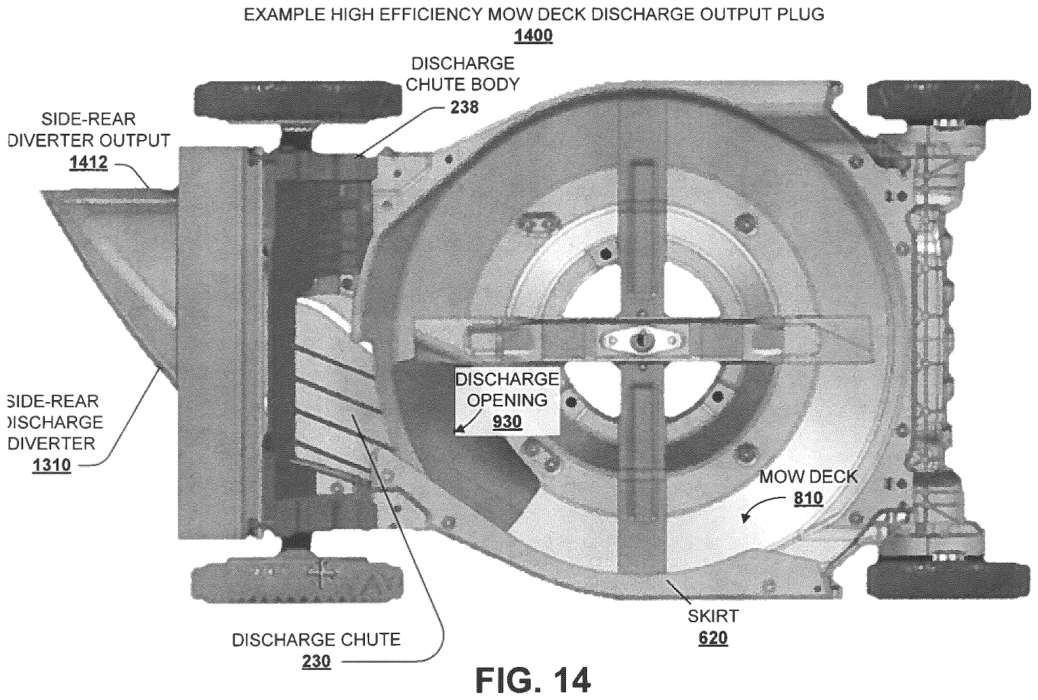

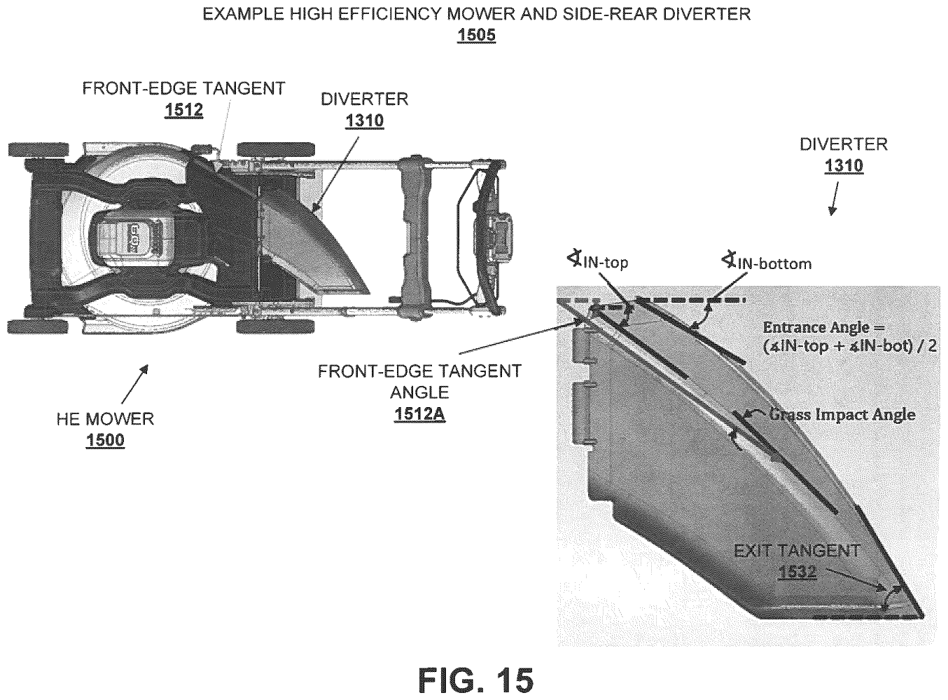

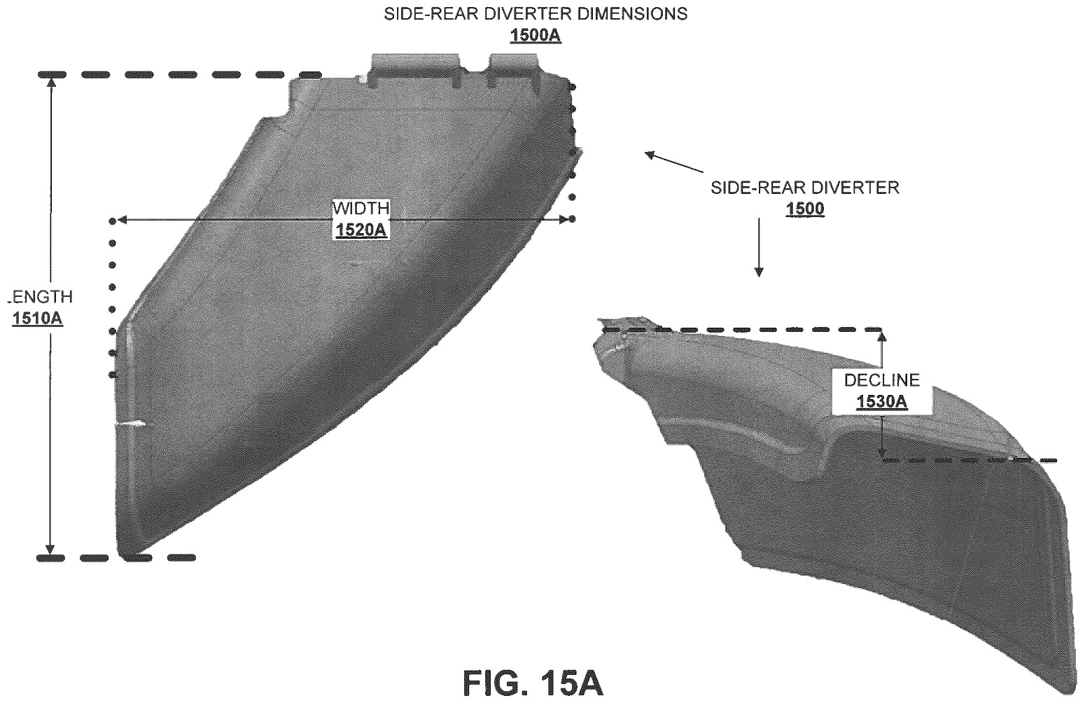

FIG. 13 depicts a rear view 1300 of a walk-behind mower with a side-rear discharge diverter 1310 positioned within discharge chute opening 235 of discharge chute body 238. Side-rear discharge diverter 1310 can have an input geometry shaped to fit snugly within discharge chute opening 235 so as to remain seated within discharge chute opening 235 during operation of a walk-behind mower. FIG. 14 depicts a bottom view 1400 of HE mow deck 810 with side-rear discharge diverter 1310 connected to a discharge chute body 238 at a rear of HE mow deck 810. A discharge chute 230 of discharge chute body 238 is coupled to HE mow deck 810 at discharge output 930. The input geometry of side-rear discharge diverter 1310 fits snugly (e.g., conformally) within discharge chute opening 235 as shown in FIG. 13. Accordingly, clippings within HE mow deck 810 ejected from discharge opening 930 (assisted by optional skirt 620 in some disclosed aspects) are conveyed through side-rear discharge diverter 1310 to a side-rear diverter output 1412 thereof. As shown in FIG. 15, a front-edge tangent line 1512 that is tangent to a perimeter of HE mow deck 810 at a front edge of discharge opening 930 (see FIGS. 4 and 5, supra) defines a right-most edge (as illustrated) for clippings ejected from HE mower 1500 to enter into side-rear discharge diverter 1310. An entrance angle can be defined by an average of a top edge input angle ( [symbol] _{IN}-top) and a bottom edge input angle ( [symbol] _{IN}-bottom). A difference between a front-edge tangent angle 1512A and the entrance angle can be between about 0 and about 5 degrees, in one or more aspects, or any suitable value or range therebetween. A grass impact angle (e.g., at a back wall of diverter 1310) can be defined by front-edge tangent angle 1512A and an edge contact point on the diverter 1310. The grass impact angle can be between 0 degrees and 17 degrees. The exit tangent angle 1532 can be between about 45 and about 60 degrees in one or more aspects, or any suitable value or range therebetween.

FIG. 15A illustrates example dimensions 1500A of side-rear diverter 1500 in additional aspects of the present disclosure. From a top-down view, a length 1500A of side-rear diverter 1500 is shown from a rear discharge edge to a discharge chute interface surface, at a top surface of side-rear diverter 1500. In an embodiment, length 1510A can be in a range from about twelve inches to about thirteen inches or any suitable value or range there between (e.g., 12.4, 12.5, 12.6, 12.7, 12.8, and so on). In another embodiment, width 1520A can be between about 11.5 inches and about 12.5 inches or any suitable value or range there between (e.g., 11.8, 11.9, 12.0, 12.2, 12.3 inches, and so on). Also shown is a decline 1530A in height of top surface of diverter 1500 from the discharge chute interface surface to the rear discharge edge. Decline 1530A can be in a range from about 2 inches to about 3 inches in further embodiments, or a suitable value or range there between.

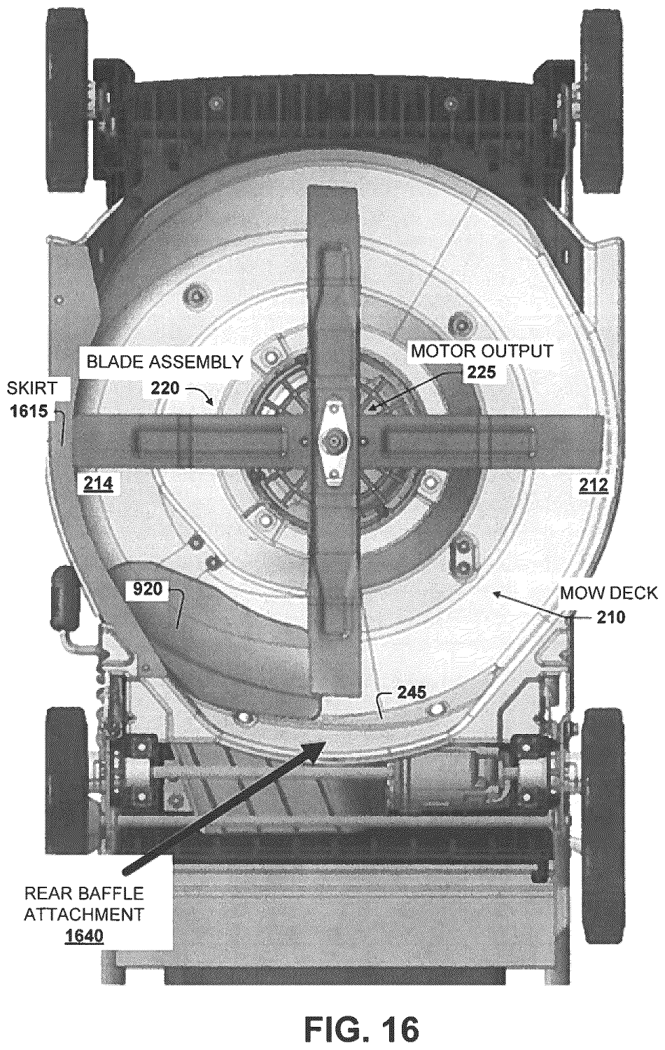

Referring now to FIG. 16, an underside view of an example walk-behind mower according to further embodiments of the present disclosure is depicted. Underside view can be of walk-behind mower 100 of FIG. 1, in some aspects of the disclosed embodiments, but is not limited to such aspects. In other aspects, the walk-behind mower depicted in FIG. 16 can have different characteristics than those shown in FIG. 1, including some of the characteristics of walk-behind mower 100, all characteristics of walk-behind mower 100, additional characteristics not shown with walk-behind mower 100, or suitable combinations of the foregoing.

The underside view in FIG. 16 shows an interior of a mow deck 210 having a blade assembly 220 secured to a motor output 225. Motor output 225 can be rotated by a motor, causing rotation of blade assembly 220. Cutting edges of individual blades of blade assembly 220 can cut vegetation within the interior of mow deck 210 during operation of the walk-behind mower, generating loose turf clippings within the interior of mow deck 210.

Turf clippings will generally move within mow deck 210 in response to rotation of air caused by rotation of blade assembly 220. The air will move in a direction of rotation of blade assembly 220 and tend to push turf clippings away from a center of rotation of blade assembly 220, toward outer edges of mow deck 210. In the embodiment illustrated by FIG. 16, blade assembly 220 rotates in a counter-clockwise direction looking from the underside view 200 of mow deck 210. This latter embodiment is not limiting and it should be understood that a mirror-image embodiment in which the blade assembly 220 rotates in a clockwise direction looking from the underside is also contemplated.

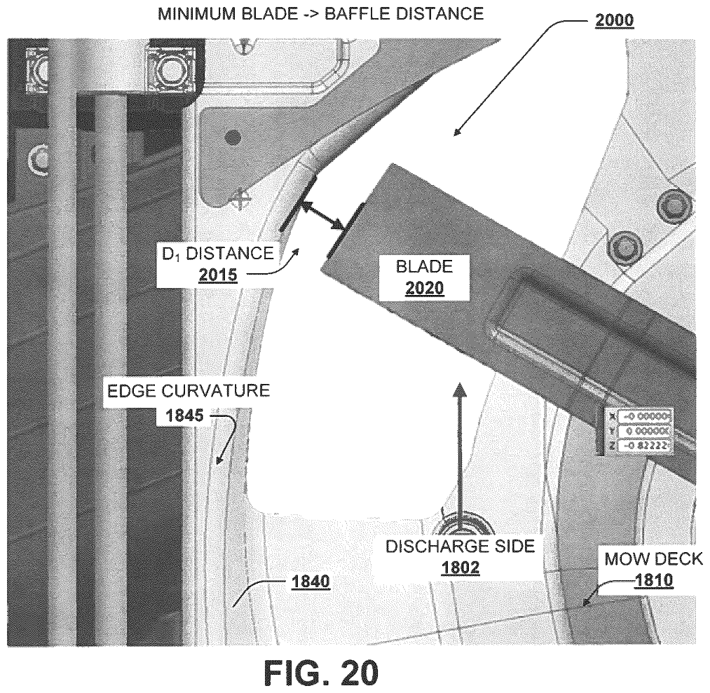

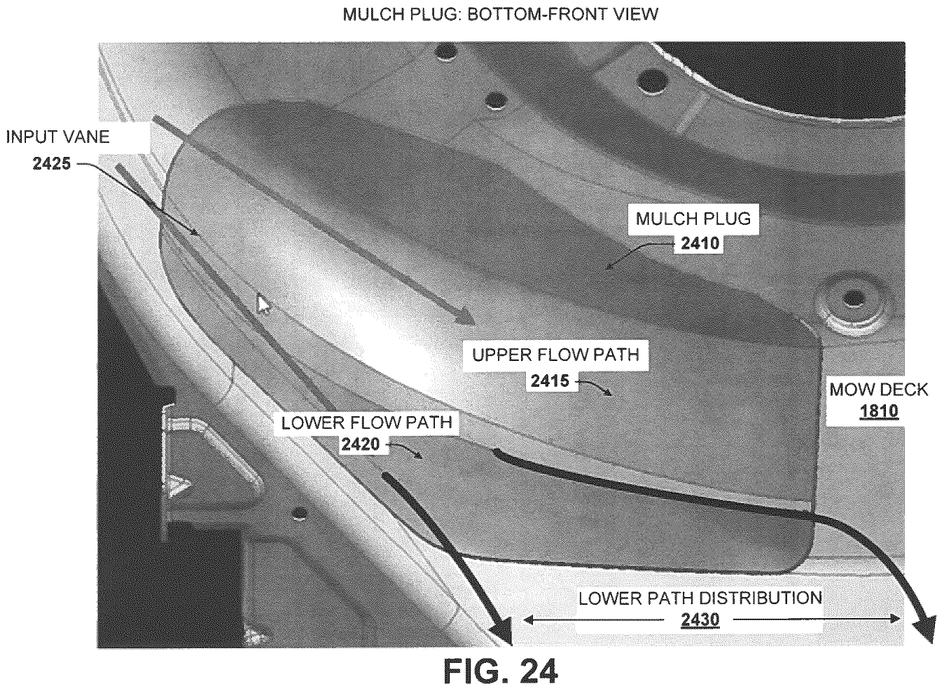

The above-referenced rotation of air caused by the rotation of blade assembly 220 may form an air vortex. Turf clippings within an air vortex inside mow deck 210 can be guided by a shape of the interior edge surface of mow deck 210. In addition, a distance between a blade tip(s) and an interior edge surface of mow deck 210 at a given position around an interior circumference of mow deck 210 can control the amount of clippings that fall below blade assembly 220 to the ground. Where a distance between the interior edge surface and a (nearest) blade tip(s) is small, few turf clippings will fall to the ground and most will remain above blade assembly 220. In the embodiment illustrated by FIG. 16, this occurs at a left side 214 and right side 212 of mow deck 210 as shown by underside view (note that left side 214 and right side 212 will be reversed when viewing a top side of mow deck 210, for example from an operator's position behind operator handles 120). At the right side 212 of mow deck 210 the blade tip(s) comes very close to the interior edge surface as shown, inhibiting turf clippings from dropping to the ground at right side 212 of mow deck 210. In addition, a deck skirt 1615 on left side 214 of mow deck 210 underlies the blade tip as it rotates through the left side 214 of mow deck 210. Deck skirt 1615 mitigates or avoids turf clippings from dropping to the ground on the left side of mow deck 210, as shown in underside view, and promotes ejection of turf clippings through discharge chute 134A when a discharge output plug 920 is not present (e.g., see FIG. 20, infra). In contrast, when discharge output plug 920 is present turf clippings are confined to the interior of mow deck 210 and guided by the interior surface of mow deck and the interior surface of discharge output plug 920 (e.g., see FIGS. 24-27).

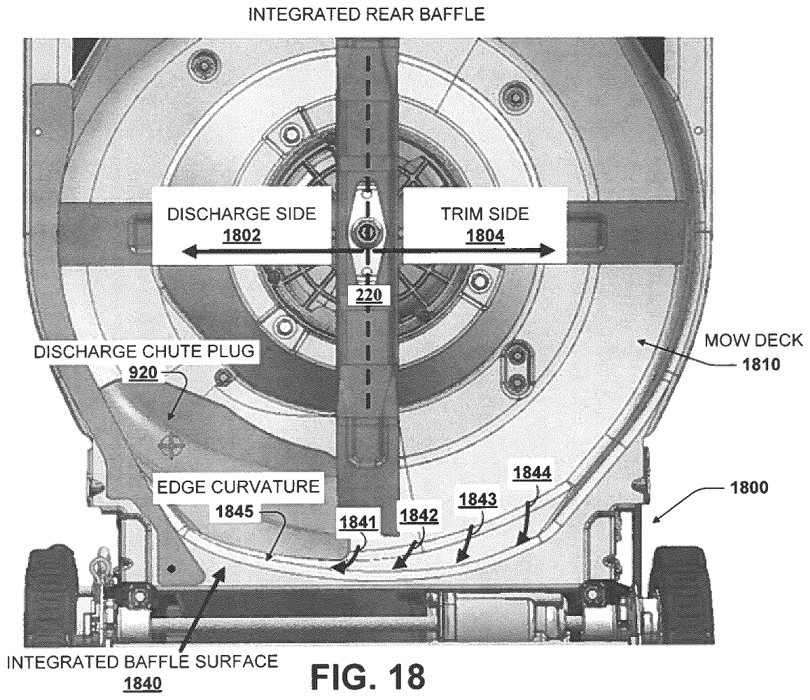

Discharge output plug 920 can have an edge surface that fits conformally within a discharge opening 930 in mow deck 210. The interior surface of discharge output plug 920 shown in the underside view of FIG. 16 can guide turf clippings within mow deck 210 after the turf clippings pass deck skirt 215. As described herein, the interior surface can be configured to direct clippings along a rear surface of mow deck 210. In the embodiment(s) depicted by FIG. 16, the rear surface can be defined by a rear baffle attachment 1640. In still other embodiments, the rear surface of mow deck 210 can define the baffle surface (e.g., see integrated baffle surface 1840 of FIG. 18, infra).

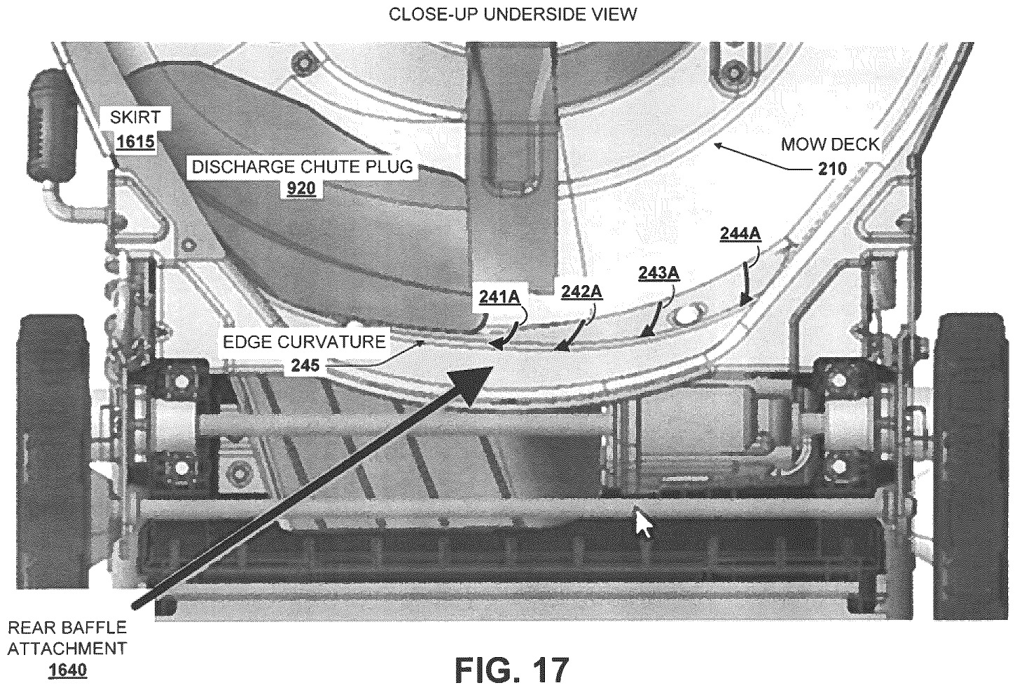

Referring now to FIG. 17, a close-up underside view of a mow deck 210 is shown having a rear baffle attachment 1640 secured to a rear inner surface of mow deck 210. Rear baffle attachment 1640 can be secured to mow deck 210 by one or more fasteners, by an epoxy or other suitable bonding agent, or the like, or a suitable combination of the foregoing.

When fastened to mow deck 210, rear baffle attachment 1640 defines an edge curvature 245 that forms a portion of an interior surface of mow deck 210 at a rear of mow deck 210. Moreover, edge curvature 245 can have a horizontal curvature (from left to right as depicted in the view shown in FIG. 16) that defines a distance between the interior surface and a (fixed) blade tip(s) of blade assembly 220 at the rear of mow deck 210. As introduced above, the distance between the interior surface and the blade tip(s) can affect distribution of clippings to the ground below mow deck 210. Moreover, edge curvature 245 can vary the distance between the interior surface and the blade tip(s) along its length (and thus along the rear of mow deck 210), to vary an amount of clippings distributed to the ground along the length of rear of mow deck 210. In at least this manner, edge curvature 245 can affect the amount of clippings distributed along portions of the rear of mow deck 210. In at least one embodiment, edge curvature 245 can be configured to improve uniformity of the distribution of clippings along the rear of mow deck 210, avoiding clumping of ejected turf clippings and improving appearance of turf clippings generated by a disclosed walk-behind mower.

In addition to the foregoing, edge curvature 245 can have a vertical curvature extending within the interior surface of mow deck 210 from an upper edge to a bottom interior edge thereof. In an embodiment(s), the upper edge of rear baffle attachment 1640 can extend to a bottom edge of discharge output plug 920, though the subject disclosure is not limited to this geometric relationship. Near a left-side of mow deck 210, as oriented by the close-up underside view of FIG. 17 (e.g., see discharge side 1802 of FIG. 18, infra), the vertical curvature has a forward slope into a center of mow deck 210 as it progresses downward to a bottom of edge curvature 245 and as shown by arrow 241A. This forward slope decreases in degree as edge curvature 245 extends from the left-side to a right side thereof (e.g., see trim side 1804 of FIG. 18, infra). For example, as the vertical curvature extends from arrow 241A to 242A and 243A a reduction in the forward slope at the bottom of edge curvature 245 is shown, until the forward slope becomes smallest as shown at arrow 244A at the right side of edge curvature 245. At the left-side the forward slope can serve, similar to skirt 215, to maintain turf clippings above blade assembly 220 and at the right-side the flatter vertical curvature shown by arrow 244A can promote distribution of clippings below blade assembly 220 to the ground.

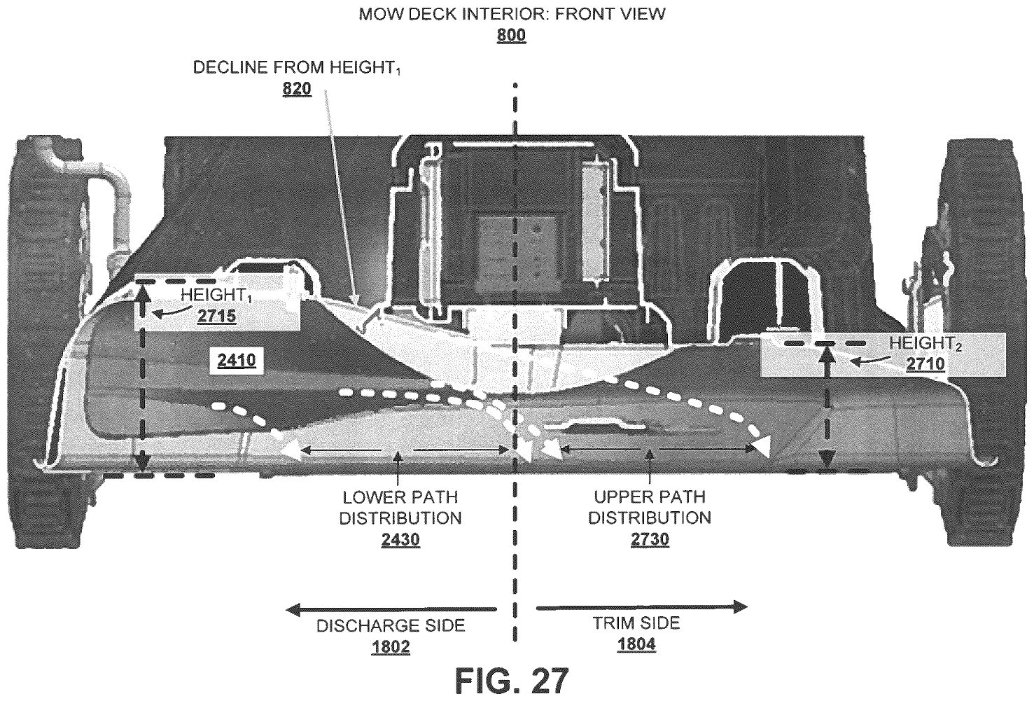

With counter-clockwise rotation of blade assembly 220, a large amount of turf clippings will first encounter rear baffle attachment 1640 upon passing skirt 1615 at the left-side thereof. Absent other conditions, a large amount of clippings would tend to fall to the ground near the left-side of mow deck 210, leading to clumped clippings and an unsightly distribution of turf clippings in a mulching mode in which discharge output plug 920 is positioned within a disclosed walk-behind mower. In various embodiments, edge curvature 245 can facilitate more uniform distribution of clippings along the rear portion of mow deck 210 by reducing clippings distributed to the ground at the left-side of mow deck 210 and increasing clipping distribution on the right-side of mow deck 210. In at least some embodiments, edge curvature 245 in combination with discharge output plug 920 can further improve uniformity of clippings distributed to the ground along the rear surface of mow deck 210 (e.g., see FIG. 27, infra).

FIG. 18 illustrates an alternative example of a mow deck 1810 having an integrated rear baffle 1800 according to further aspects of the disclosed embodiments. For ease of explanation, mow deck 1810 is orientated with a discharge side 1802 on a left-hand side of mow deck 1810 with discharge output plug 920 (and a discharge opening 930 of mow deck 310) as shown by FIG. 18, and a trim side 1804 on a right-hand side of mow deck 1810.

Integrated rear baffle 1800 includes an integrated baffle surface 1840 formed in mow deck 1810. Integrated baffle surface 1840 can have an edge curvature 1845 defining an interior surface of mow deck 1810 at a rear portion thereof. In some aspects of the disclosed embodiments, edge curvature 1845 can define the same interior surface as edge curvature 245 of FIGS. 16 and 17, supra. However, in other aspects, edge curvature 1845 can vary from edge curvature 245 to achieve a target (variable) rear surface->blade tip depth along the rear interior surface, to account for a difference in thickness of the rear mow deck surface without rear baffle attachment 1640.

Edge curvature 1845 can have a horizontal curvature that defines a distance from a blade tip(s) of blade assembly 220 to the rear interior surface. Further, as described above with FIGS. 16 and 17, the distance can vary from a first end at discharge side 1802 of edge curvature 345 to a second end at trim side 1804. In various aspects of the present disclosure, the distance at the left-most end of edge curvature 1845 at discharge side 1802 can define a smallest distance between the blade tip(s) and rear interior surface, whereas the distance at the right-most end of edge curvature 1845 at trim side 1804 can define a greatest distance between the blade tip(s) and rear interior surface.

Additionally, edge curvature 1845 can have a vertical curvature extending at an upper edge from discharge output plug 920 to a bottom edge of mow deck 1810. The vertical curvature can define a more pronounced curvature on discharge side 1802, as illustrated by the relatively sharper curve of arrows 1841 and 1842 modeling the vertical curvature near the middle of edge curvature 1845. In contrast, the vertical curvature can also define a less pronounced curvature as edge curvature 1845 extends further along trim side 1804 as shown by arrow 1843 to a nearly flat curvature at the furthest end of edge curvature 1845 on trim side 1804.

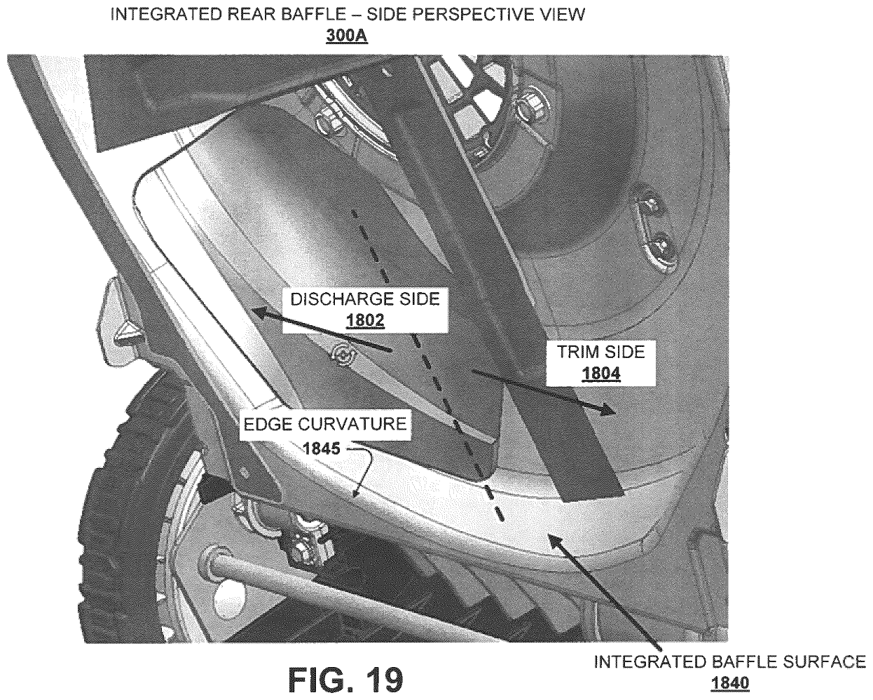

FIG. 19 provides a side perspective view of integrated rear baffle 1800. Edge curvature 1845 of integrated baffle surface 1840 extends from a discharge side 1802 to a trim side 1804 of the rear interior surface of mow deck 1810. Minimum blade to baffle distance 2000 is shown by FIG. 20. As is evident from FIG. 20, a distance D₁ 2015 is defined between a tip of blade 2020 and an interior surface of edge curvature 1845 of integrated baffle surface 1840 on discharge side 1802 of mow deck 1810. FIG. 20 also depicts a discharge opening 930 formed in a discharge side 1802 of mow deck 1810 (with discharge output plug 920 removed). Distance D₁ 2015 can be the same or approximately the same between a tip of blade 2020 and an interior surface of edge curvature 245 of rear baffle attachment 1640 in various embodiments.

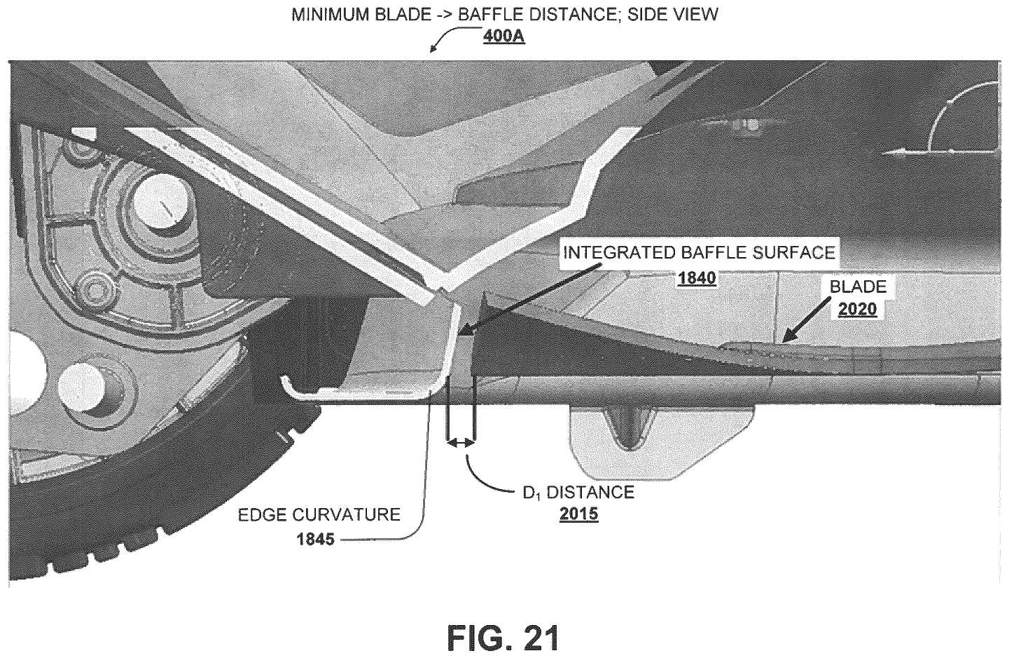

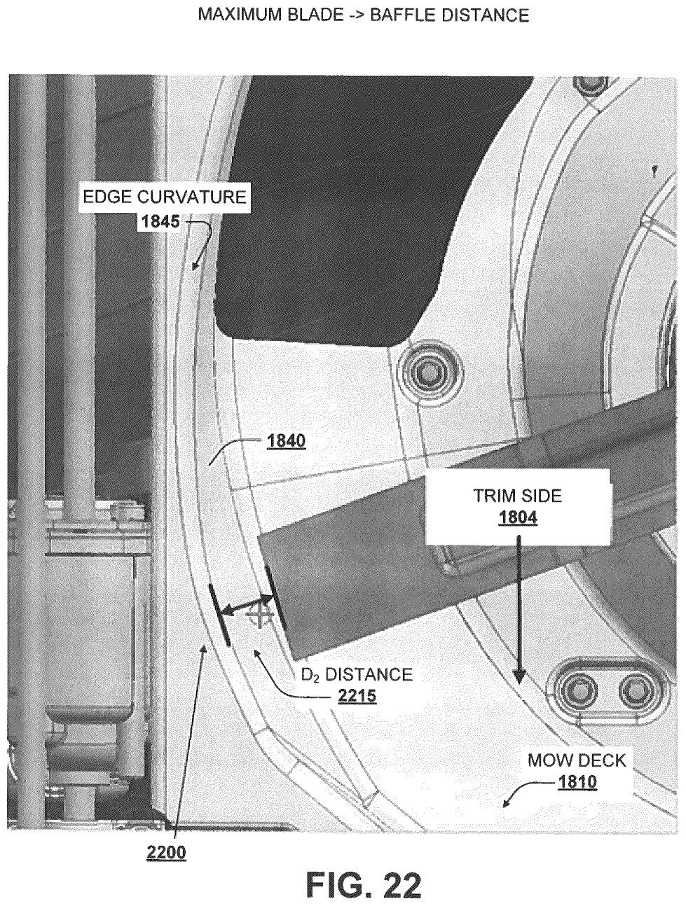

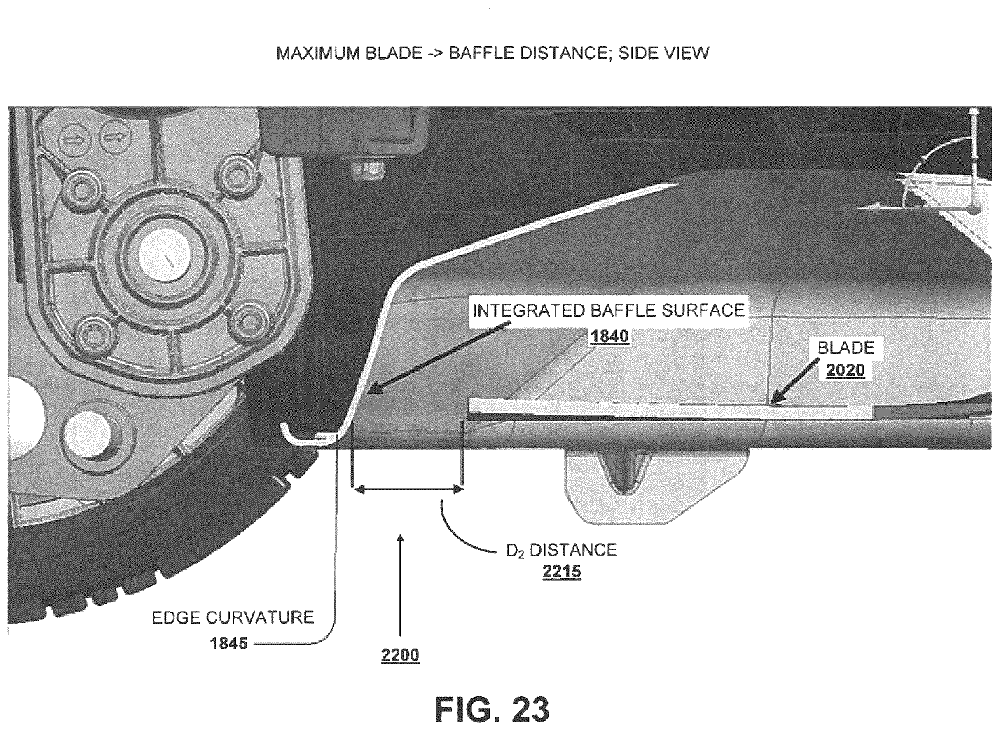

FIG. 21 shows a side view of the minimum blade to baffle distance 2000 (not to scale). Distance D₁ 2015 between edge curvature 1845 of integrated baffle surface 1840 is more clearly visible from side view of FIG. 21. In contrast, FIGS. 22 and 23 show a second distance D₂ 2215 between a blade tip and edge curvature 1845 of integrated baffle surface 1840 at trim side 1804 of mow deck 1810. In various embodiments, distance D₂ can be a maximum blade to baffle distance 2200 and moreover D₂ 2215>D₁ 2015. In an aspect(s), the minimum distance D₁ 2015 can be within a range from about fifty percent to about ninety percent of the maximum distance D₂ 2215.

As stated previously, the distance between blade 2020 and integrated baffle surface 1840 can vary along a length of integrated baffle surface 1840 between discharge side 1802 and trim side 1804. FIG. 23 provides a side view of the maximum blade to baffle distance 2200 at trim side 1804. Though not to scale, side view of maximum blade to baffle distance 2200 depicts the variation from the side view of the minimum blade to baffle distance 2000. In some aspects of the disclosed embodiments, maximum blade to baffle distance D₂ 2215 can be in a first range from about 1.0 inches to about 1.2 inches, or any suitable value or range there between. In further aspects, minimum blade to baffle distance D₁ 2015 can be in a second range from about 0.7 inches to about 0.9 inches, or any suitable value or range there between.

In the embodiments provided by FIGS. 16-23, discharge output plug 920 is positioned on the left-side of the mow deck (as viewed from under the mow deck) and corresponds with a counter-clockwise direction of rotation of blade assembly 220 (also as viewed from under the mow deck). In addition to the foregoing, the left-right orientation of edge curvature 1845 (and of edge curvature 245) is provided for a walk-behind mower with the counter-clockwise rotation of blade assembly 220. In other embodiments with a clockwise rotation of blade assembly 220, discharge side 1802 and trim side 1804 can be swapped, a discharge opening and discharge output plug can be on the right side of mow deck 1810 (matching the new position of discharge side 1802) and the horizontal curvature of edge curvature 1845 and the progression of vertical curvature represented by arrows 1841, 1842, 1843 and 1844 (and 241A, 242A, 243A and 244A) can be inverted from left to right from that shown in FIGS. 16, 17, 18 and 19.

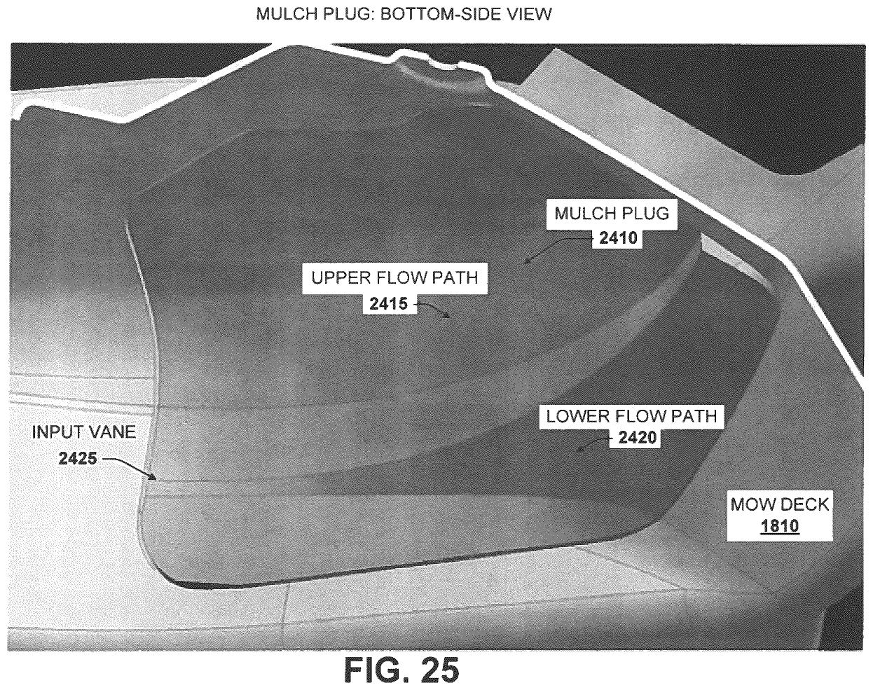

FIGS. 24 and 25 illustrate a bottom-front view and bottom-side view, respectively, of a mulch plug 2410 for a mow deck 1810 of a disclosed walk-behind mower, in various embodiments. Mulch plug 2410 can fit conformally within a discharge opening of mow deck 1810 (e.g., see FIG. 20, supra). In addition, mulch plug 2410 can have an interior surface that defines a plurality of flow paths for air and clippings moving within mow deck 1810 in response to rotation of blade assembly 220. As illustrated by mulch plug 2410, the plurality of flow paths includes a lower flow path 2420 and an upper flow path 2415. An input vane 2425 separates the upper flow path 2415 from the lower flow path 2420 and separates clippings traversing the interior edge of mow deck 1810 into the upper flow path 2415 and the lower flow path 2420.

Lower flow path 2420 provides a flow output that defines a lower path distribution 2430 of turf clippings. The lower path distribution 2430 can be configured to distribute turf clippings along discharge side 1802 of mow deck 1810, as shown by the output arrows at the left and right edges of lower path distribution 2430. Moreover, the turf clippings distributed along lower path distribution 2430 can be directed onto integrated baffle surface 1840 (or rear baffle attachment 1640), which can control distribution of turf clippings to the ground as discussed above. Accordingly, lower flow path 2420 and integrated baffle surface 1840 can function synergistically to improve uniformity of clipping distribution along lower path distribution 2430 on a discharge side 1802 of mow deck 1810.

In various embodiments, an amount of clippings directed to upper flow path 2415 and lower flow path 2420 can be determined at least in part by a height of input vane 2425. To increase proportion of turf clippings directed onto lower flow path 2420 input vane 2425 can be positioned higher along a height of mulch plug 2410. To increase proportion of turf clippings directed onto upper flow path 2415 input vane 2425 can be positioned lower along the height of mulch plug 2410.

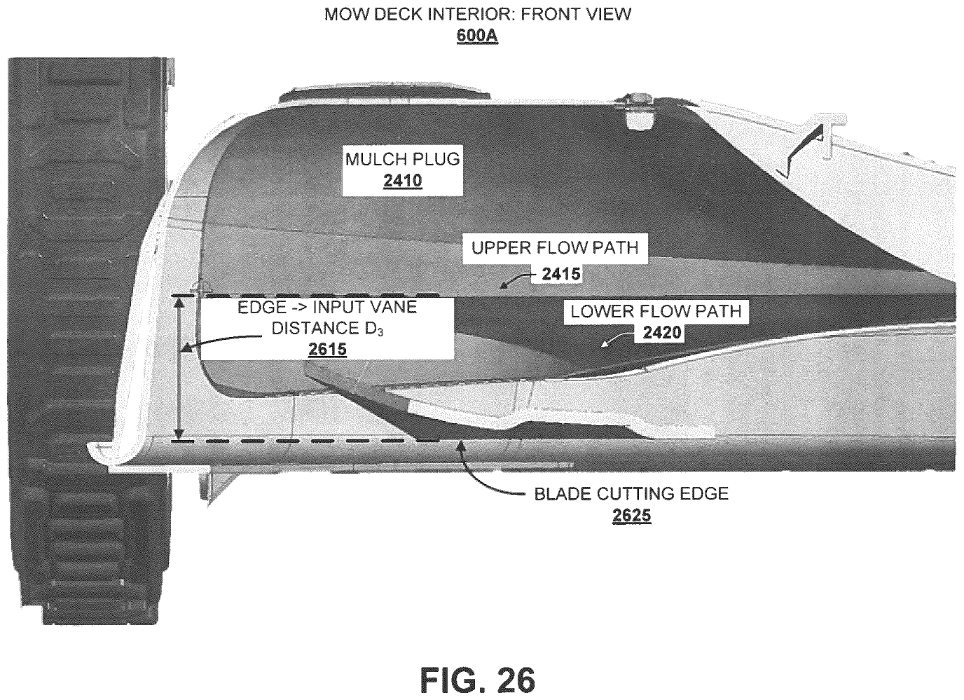

In one or more embodiments, the height of input vane 2425 can be define with respect to a cutting edge of one or more blades of blade assembly 220. In FIG. 26, a front view of a mow deck interior is shown. The front view of FIG. 26 illustrates a distance D₃ 2615 between a blade cutting edge 2625 and a height of input vane 2425. In one or more aspects of the present disclosure, distance D₃ 2615 can be within a range from about 0.8 inches to about 1.2 inches.

FIG. 27 provides a full front view of a mow deck 1810 of a walk-behind mower according to further aspects of the disclosed embodiments. Front view shows a right side of the mow deck (e.g., trim side 1804) opposite a left side thereof (e.g., discharge side 1802). As discussed above at FIG. 24, a lower path distribution 2430 includes turf clippings output from a lower flow path 2420 of mulch plug 2410 primarily throughout discharge side 1802. In contrast, an upper path distribution 2730 receives turf clippings output from an upper flow path 2415 of mulch plug 2410. As shown, upper path distribution 2730 is primarily along trim side 304 of mow deck 1810.

Mow deck 1810 can be asymmetric in height, having a second height H₂ 2710 on the trim side 1804 of mow deck 1810, and having a first height H₁ 2715 on the discharge side 1802 of mow deck 1810. In some disclosed aspects, first height H₁ 2715 can define a maximum interior mow deck height measured from a bottom edge of mow deck 1810 to a top of mow deck 1810 at first height H₁ 2715 (as shown by the dashed double-ended arrows). This maximum interior mow deck height can be within a range from about 3 inches to about 5.5 inches. In further disclosed aspects, second height H₂ 2710 can define a minimum interior mow deck height measured from the bottom edge of mow deck 1810 to a top of mow deck 1810 at second height H₂ 2710 (as shown by the dashed double-ended arrows). This minimum interior mow deck height can be within a second range from about 2.25 inches to about 2.75 inches. In alternative or additional aspects of the disclosed embodiments, the maximum interior mow deck height can be within a third range from about 15 percent to about 95 percent larger than the minimum interior mow deck height.

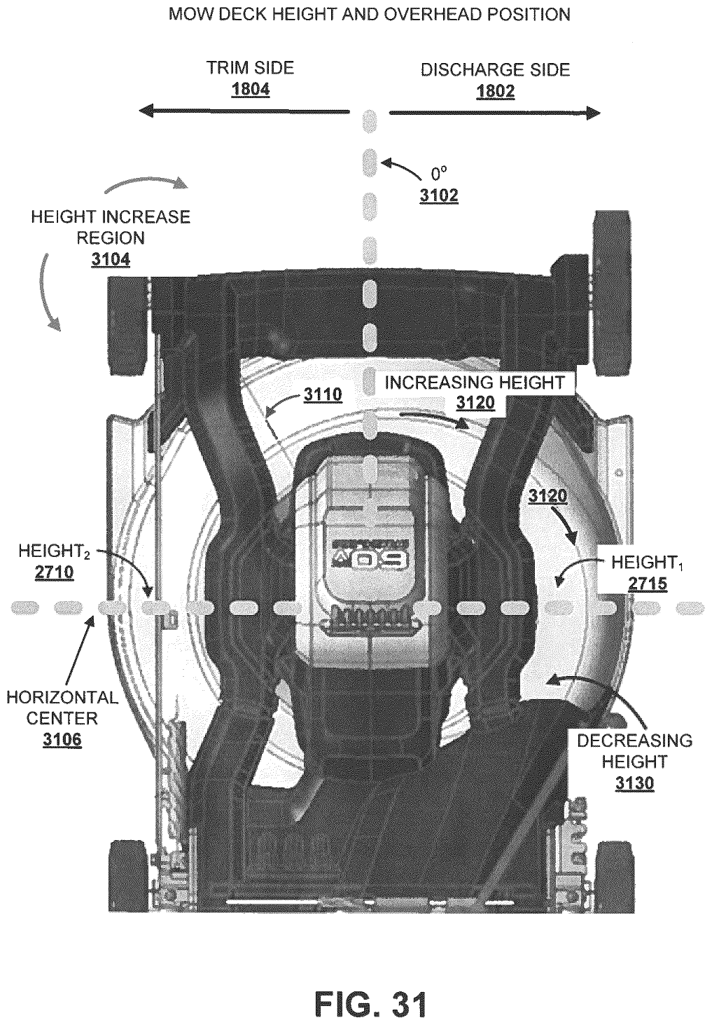

The increased height of mow deck 1810 on discharge side 1802 can facilitate an upward flow of air within the interior of mow deck 1810 on discharge side 1802 caused by a lift blade of blade assembly 220 that forces air upward within mow deck 1810 in response to rotation of blade assembly 220. This upward flow of air forms an upward (air) fluid vector that also can cause turf clippings to rise within the interior of mow deck 1810. This upward flow of air increases above second height H₂ 2710 where the interior height of mow deck 1810 also begins to increase from second height H₂ 2710 on trim side 1804 in a frontward direction about mow deck 1810 (e.g., see FIG. 31, infra) toward first height H₁ 2715 on discharge side 1802. A maximum height of mow deck 1810 is represented at first height H₁ 2715.

When mulch plug 2410 is not positioned within a discharge opening of mow deck 1810, this upward flow of air helps to bring turf clippings into alignment with a discharge opening formed in mow deck 1810 (e.g., see FIG. 20, supra), improving evacuation of the turf clippings from mow deck 1810. When mulch plug 2410 is positioned within the discharge opening of mow deck 1810, the upward flow of air brings the turf clippings into contact with the interior surface of mulch plug 2410 to be divided by input vane 2425 along lower flow path 2420 and upper flow path 2415, as described previously.

In addition to the foregoing, the interior height of mow deck 1810 can decrease from first height H₁ 2715 at a rear portion of mow deck 1810 (see FIG. 31) above mulch plug 2410 toward second height H₂ 2710. This is demonstrated by decline from height H₁ 2715 shown in FIG. 8. The decline from height H₁ 2715 at the rear portion of mow deck 1810 likewise creates a downward flow of air and a downward (air) fluid vector at the rear portion of mow deck 1810. The downward fluid vector directs turf clippings moving along upper flow path 2415 downward from first height H₁ 2715 at the rear of mow deck 1810 onto upper path distribution 2730 at trim side 1804 of mow deck 1810. The distribution of the turf clippings from upper flow path 2415 onto upper path distribution 2730 at trim side 1804 of mow deck 1810 further facilitates uniform distribution of turf clippings along the rear portion of mow deck 1810: turf clippings from lower flow path 2420 being distributed across lower path distribution 2430 and turf clippings from upper flow path 2415 being distributed across upper path distribution 2730. This can serve to minimize clumping of turf clippings and increase aesthetic appearance of clippings ejected from mow deck 1810 with mulch plug 2410 in place.

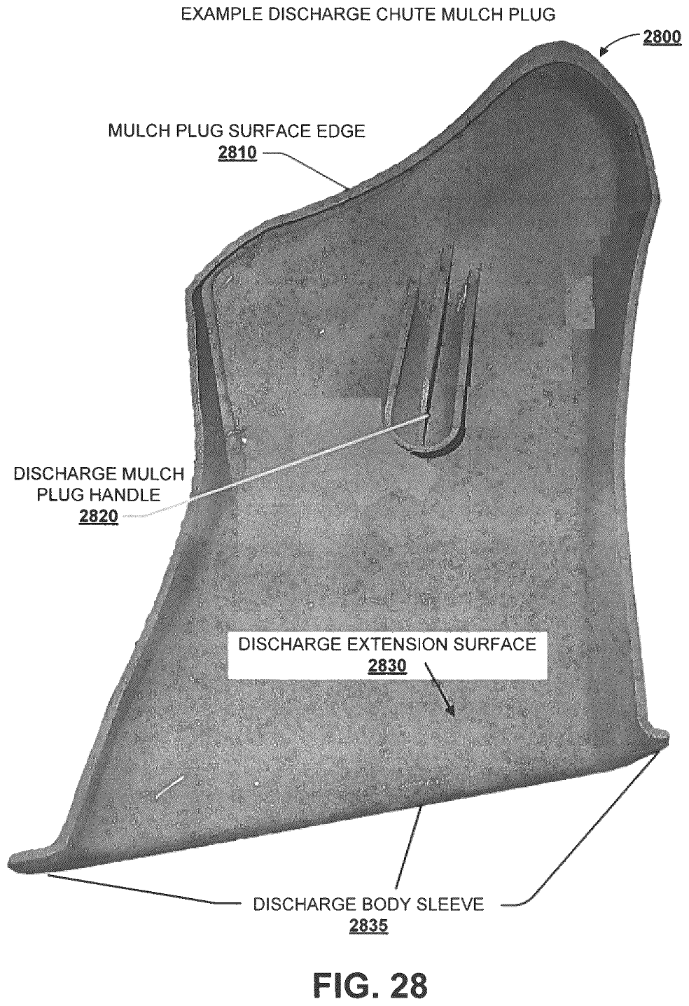

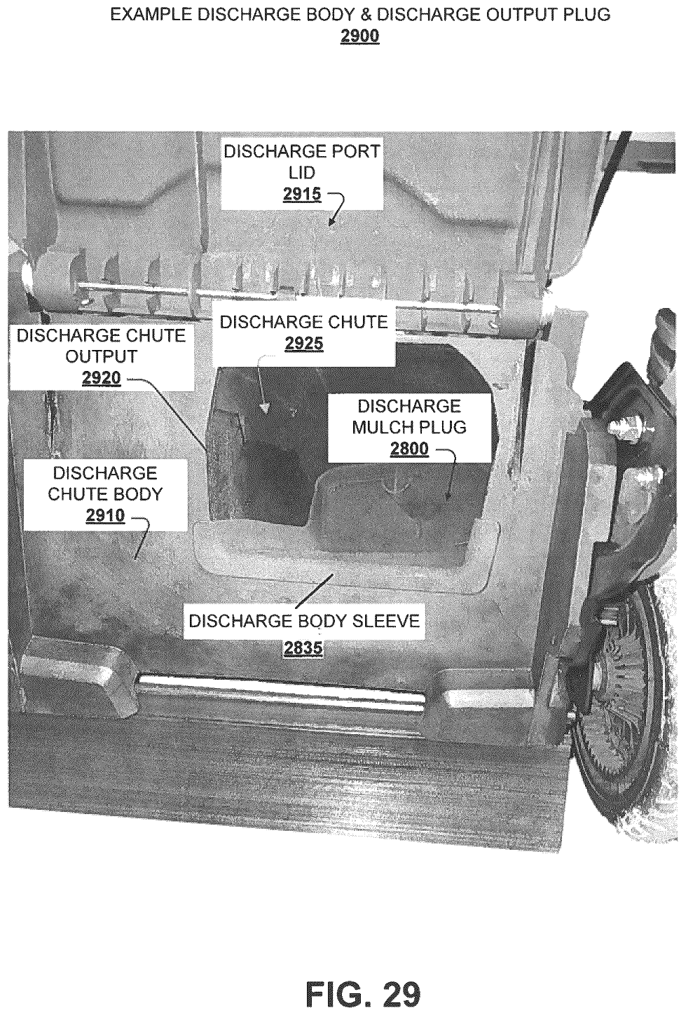

FIG. 28 illustrates an example discharge chute mulch plug 2800 according to alternative or additional aspects of the disclosed embodiments. Discharge chute mulch plug 2800 is shown from an exterior surface exposed to a top or outside of a mow deck. In an embodiment where a walk-behind mower includes a discharge body overlying the discharge opening and top of the mow deck, the exterior surface of discharge chute mulch plug 2800 can be visible from a top or rear opening of the discharge body (e.g., see FIG. 29, infra).

As shown, discharge chute mulch plug 2800 comprises a mulch plug surface edge 2810 that can be seated upon a perimeter of a discharge opening (see FIG. 20, supra) of a disclosed mow deck (e.g., mow deck 1810). A discharge mulch plug handle 920 can be provided on the top (exterior) surface of discharge chute mulch plug 2800, facilitating hand placement and removal of discharge chute mulch plug 2800 into position upon the perimeter of the discharge opening of a mow deck. A discharge extension surface 2830 can be provided extending from mulch plug surface edge 2810, which can rest upon an interior surface of a discharge body coupled to the mow deck, in at least some embodiments (FIG. 29). A discharge body sleeve 2835 can extend at an angle from discharge extension surface 2830 to seat upon an outer edge of the discharge body and hold discharge chute mulch plug 2800 in position with respect to the discharge opening of the mow deck and optionally with respect to the discharge body. In at least one disclosed aspect, discharge body sleeve 2835 can extend perpendicular or substantially perpendicular from discharge extension surface 2830 in at least one aspect, though the subject disclosure is not limited to this aspect(s).

FIG. 29 shows an example discharge chute body 2900 from a rear perspective view (e.g., at an operator's position of a walk-behind mower). Discharge chute body 2900 can be attached or secured to at least a portion of a top surface, and at a rear portion of a mow deck of a walk-behind mower. Moreover, discharge chute body 2900 can attach to and cover a discharge opening of the mow deck. A discharge chute 2925 defines an opening having an input coupled to the discharge opening in the mow deck and having a discharge chute output 2920 at a rear surface of discharge body 2900. In an embodiment, discharge chute 2925 can be the same or similar to discharge chute 134A of FIG. 1A, though discharge chute 2925 of discharge chute body 2900 can vary from discharge chute 134A in other embodiments.

Discharge mulch plug 2800 can be inserted into discharge chute 2925 from the output thereof and positioned conformally with the discharge opening of the mow deck at the input of discharge chute 2925. Further, mulch plug surface edge 2810 can be positioned conformally with the discharge opening in the mow deck at the input of discharge chute 2925, effectively blocking flow of turf clippings from the interior of the mow deck to discharge chute 2925. In various embodiments, discharge mulch plug 2800 can have an interior surface (opposite the exterior surface coupled to discharge mulch plug handle 2820) of mulch plug 2410 shown in FIG. 24, supra, defining upper flow path 2415, lower flow path 2420 and input vane 2425.

In one or more aspects of the disclosed embodiments, a discharge port lid 2915 can be provided attached to an upper edge of discharge chute body 2910. Discharge port lid 2915 can fold down over discharge chute body 2910 and discharge chute 2925 when discharge mulch plug 2800 is inserted within discharge chute 2925. With discharge port lid 2915 lifted, an operator can grasp discharge mulch plug handle 2820 to remove discharge mulch plug 2800 from discharge chute 2925, or reinsert discharge mulch plug 2800 into discharge chute 2925.

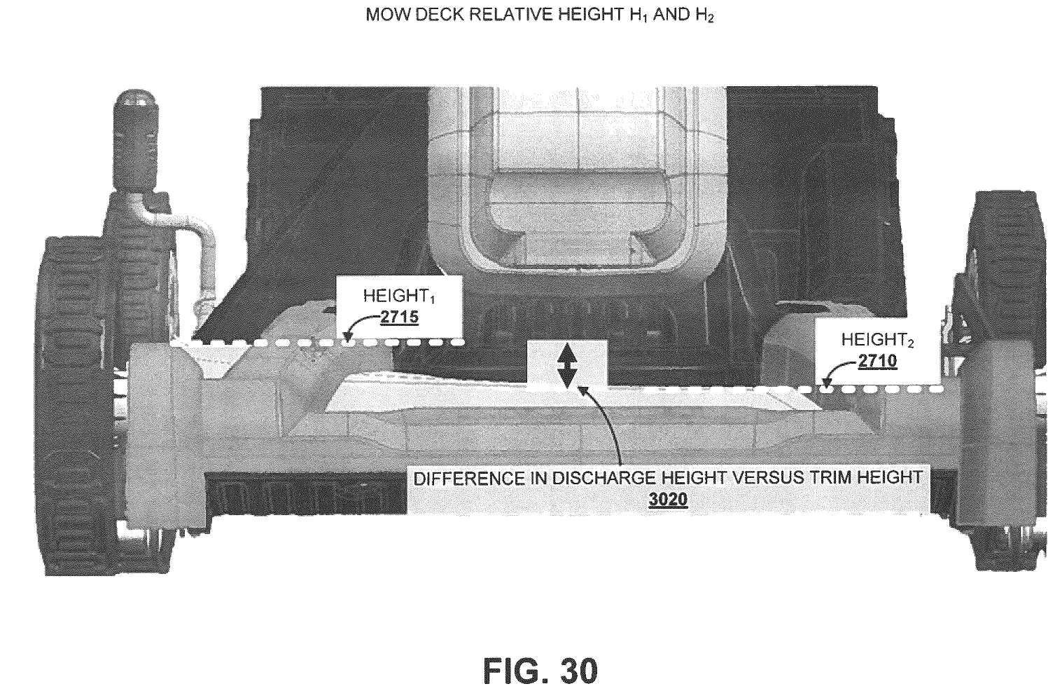

FIG. 30 shows a front view of a mow deck of a walk-behind mower in a manner to highlight an asymmetric height of the mow deck. A trim side of the mow deck is associated with a height H₂ 2710 and a discharge side of the mow deck is associated with a height H₁ 2715. Note that the trim side and height H₂ 2710 can be swapped with the discharge side and height H₁ 2715 in some aspects of the subject disclosure (e.g., where a blade assembly of the walk-behind mower is driven in a clockwise direction, viewed from an underside of the mow deck). A difference 3020 in discharge height versus trim height of the mow deck is shown.

FIG. 31 shows an overhead view of the mow deck of FIG. 30. A trim side 1804 of the mow deck is associated with height H₂ 2710 and a discharge side 1802 of the mow deck is associated with height H₁ 2715. The overhead view of FIG. 31 depicts example positions about a top surface of the mow deck where height H₂ 2710 begins to increase to height H₁ 2715, and where height H₁ 2715 begins to decrease to height H₂ 2710. To this end, the overhead view of FIG. 31 defines a horizontal centerline 3106 extending from left to right across the figure and a zero degree line 3102 bisecting trim side 1804 from discharge side 1802. In various aspects of the present disclosure, the mow deck height can increase from height H₂ 2710 within height increase region 3104 on trim side 1804 and forward of horizontal centerline 3106 (e.g., viewed from an operator's position behind the mow deck). For instance, in some aspects height H₂ 2710 can begin to increase coincident with or approximately coincident with horizontal centerline 3106, about 90 degrees from zero degree line 3102. In further aspects, height H₂ 2710 can begin to increase from height H₂ 2710 anywhere within height increase region 3104 from horizontal centerline 3106 (about 90 degrees from zero degree line 3102) to zero degree line 3102. In at least one aspect, height H₂ 2710 can increase at inflection point 3110 about thirty degrees from zero degree line 3102 within height increase region 3104.

From inflection point 3110 height of the mow deck can increase along increasing height path 3120 until a maximum height is reached at height H₁ 2715. Further, from height H₁ 2715 the mow deck can begin to decrease in height along decreasing height path 3130 behind horizontal centerline 1206 (from the operator's perspective). The decreasing height can continue until reaching a minimum height at height H₂ 2710. As described herein, increasing height path 3120 can facilitate an upward (air) fluid flow within an interior of the mow deck to cause turf clippings to rise upward to a discharge opening (or an interior surface of a mulch plug 2410) in the mow deck. Likewise, decreasing height path 3130 can facilitate a downward (air) fluid flow within the interior of the mow deck to cause turf clippings to fall toward an edge curvature 1845 of a rear interior surface of the mow deck to facilitate distribution of the turf clippings along an upper path distribution 2730, as described herein. One of skill in the art would understand that one of ordinary skill in the art could modify the explicit aspects disclosed herein consistent with the scope of the present disclosure.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein. As an example, an arrangement of components depicted in one embodiment can be swapped with components depicted in another embodiment, optionally excluding some components or including other components illustrated in a third embodiment, according to design creativity of one of ordinary skill in the art. For instance, rear baffle attachment 1640 can be attached to mow deck 1810 of FIG. 24 as shown in FIG. 16, and can function in conjunction with lower flow path 2420 and upper flow path 2415 of mulch plug 2410 as described herein. In yet a simpler example, discharge chute body 2900 can be coupled to mower body 110A of FIG. 1A and can incorporate discharge chute 134A and be mechanically coupled to bag 132A of bagging apparatus 130A, in suitable aspects of the present disclosure. As a further example, components of disclosed devices can be implemented as connected to other components rather than included within the parent device. Alternatively, the opposite orientation can be implemented within the scope of the disclosure: one component depicted separate from another component can be aggregated as a single component in some embodiments. Additionally, it is noted that one or more disclosed processes can be combined into a single process providing aggregate functionality. Still further, components of disclosed machines/devices/sensors/control units can also interact with one or more other components not specifically described herein but known by those of skill in the art.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as hardware configured to implement the functions, including mechanical hardware, electronic hardware, and computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

According to the foregoing, the present subject matter may take a variety of aspects, some of which are set out expressly below. The following aspects are exemplary and are not intended to be limiting. Ordinal language (first, second, third, etc.) used in the following merely indicates examples and to avoid confusion and is not intended to express or imply any order or hierarchy.

In a first aspect the present subject matter is a grass mowing apparatus, comprising: a plurality of front wheels and a plurality of rear wheels; a mow deck; a blade apparatus secured to the mow deck and secured to a plurality of blades, the blade apparatus configured to drive motion of the plurality of blades within an interior of the mow deck in response to a force applied to the blade apparatus and the plurality of blades comprising more than two blades; an electric motor coupled to the blade apparatus and configured to supply the force to the blade apparatus; a rechargeable battery for providing electrical power to the electric motor; a discharge opening defined in a side-rear portion of the mow deck, wherein the discharge opening has a leading edge behind a right-most side of the mow deck and a trailing edge near a rear-most side of the mow deck; and a discharge chute body having a discharge chute input and a discharge chute output, wherein the discharge chute input of the discharge chute body is fluidly coupled with the discharge opening defined in the mow deck such that air and clippings within an interior of the mow deck enter the discharge chute body from the discharge opening and the discharge chute input and exit the discharge chute body through the discharge chute output.

A second aspect is an optional form of the first aspect, wherein the mow deck defines a perimeter that, when viewed from above and behind the mow deck, has a zero angle at the front-most side in a direction of motion of the grass mowing apparatus, a ninety degree angle at the right-most side and a one-hundred eighty degree angle at the rear-most side, and further wherein the leading edge is defined at greater than the ninety degree angle around the perimeter of the mow deck.

A third aspect is an optional form of the second aspect, wherein the trailing edge is defined at less than the one-hundred eighty degree angle around the perimeter of the mow deck.

A fourth aspect is an optional form of the second aspect, further comprising a bagging apparatus secured over the discharge chute output of the discharge chute body, wherein the leading edge of the discharge opening intersects an outer perimeter of the mow deck at a point through which a tangent line to the outer perimeter that intersects the point also intersects a rear wall of the bagging apparatus.

A fifth aspect is an optional form of the first aspect, wherein a first blade of the plurality of blades is positioned perpendicular to or approximately perpendicular to a second blade of the plurality of blades.

A sixth aspect is an optional form of the fifth aspect, wherein the plurality of blades comprises at least four blades respectively positioned at right angles or approximately right angles there between.

A seventh aspect is an optional form of the first aspect, wherein a blade of the plurality of blades is a lift blade providing upward force on turf clippings cut by the plurality of blades.

An eighth aspect is an optional form of the seventh aspect, wherein a second blade of the plurality of blades is a flat blade providing little to no upward force on the turf clippings cut by the plurality of blades.

A ninth aspect is an optional form of the first aspect, wherein the plurality of blades has a first clearance distance between a furthest end of the plurality of blades and an interior of the right-most side of the mow deck and has a second clearance distance between the furthest end of the plurality of blades and an interior of the rear-most side of the mow deck, wherein the first clearance distance is smaller than the second clearance distance.

A tenth aspect is an optional form of the ninth aspect, wherein the plurality of blades has the first clearance distance between the furthest end of the plurality of blades and an interior of a left-most side of the mow deck.

An eleventh aspect is an optional form of the ninth aspect, wherein the plurality of blades has the second clearance distance or approximately the second clearance distance between the furthest end of the plurality of blades and an interior of a front-most side of the mow deck.

A twelfth aspect is an optional form of the first aspect, wherein the rear-most side of the mow deck has an interior wall that forms an angle to a flat surface on which the grass mowing apparatus rests in a range of about thirty degrees to about sixty degrees.

A thirteenth aspect is an optional form of the twelfth aspect, wherein the front-most side of the mow deck has a second interior wall that forms a second angle to the flat surface in the range of about thirty degrees to about sixty degrees.

A fourteenth aspect is an optional form of the twelfth aspect, wherein the right-most side of the mow deck has a second interior wall that forms a second angle to the flat surface in a second range of about eighty five to about ninety five degrees.

A fifteenth aspect is an optional form of the eleventh aspect, further comprising a single-point frame lift comprising a left-right frame coupling and a front-rear frame coupling that raises and lowers the plurality of front wheels and the plurality of rear wheels above a surface in response to mechanical adjustment of the single-point frame lift.

A sixteenth aspect is an optional form of the first aspect, further comprising a turf guide extending from the right-most side of the mow deck toward a front edge of the mow deck and having a front-facing creased turf guide surface that guides grass blades interacting with the front-facing creased turf guide inward from a perimeter of the mow deck to be cut by the plurality of blades.

A seventeenth aspect is an optional form of the first aspect, further comprising a skirt secured to a bottom surface of the mow deck on a side of the discharge opening that mitigates clippings from falling below the bottom surface of the mow deck on the side of the discharge opening containing the baffle.

An eighteenth aspect is an optional form of the first aspect, further comprising a discharge output plug configured to sit within the discharge chute output of the discharge chute body and prevent air and clippings within the interior of the mow deck from exiting the mow deck through the discharge opening.

A nineteenth aspect is an optional form of the eighteenth aspect, further comprising a mulch ejection port at the rear-most side of the mow deck near a bottom surface of the mow deck configured to disperse clippings out from the interior of the mow deck behind the grass mowing apparatus.

A twentieth aspect is an optional form of the nineteenth aspect, wherein the mulch ejection port has a tapered perimeter having a decreasing height in a direction of rotation of the plurality of blades within the interior of the mow deck.

A twenty-first aspect is an optional form of the first aspect, further comprising a side-discharge diverter removably coupled with the discharge chute output of the discharge chute body, and when coupled with the discharge chute output, the side-discharge diverter guides clippings ejected from the mow deck into the discharge chute body to a left side or a right side of the grass mowing apparatus.

A twenty-second aspect is an optional form of the first aspect, further comprising a frame secured to the plurality of front wheels, to the plurality of rear wheels and secured to the mow deck, and operator handles secured to the frame, wherein the grass mowing apparatus is a walk-behind apparatus that is guided or pushed by an operator utilizing the operator handles.

In a twenty-third aspect the present subject matter is a mow deck for a walk-behind power equipment device, comprising: a front portion, a rear portion and a side portion of the mow deck; a plurality of frame mounts at the rear portion of the mow deck for securing the mow deck to a frame and to a discharge body of a walk-behind power equipment device; a center portion defining an opening through a surface of the mow deck and having a seat to support a blade apparatus and an electric motor and one or more mounts to secure the blade apparatus and the electric motor to the mow deck; a discharge opening defining a second opening through the surface of the mow deck near a perimeter of the mow deck and between the rear portion and the side portion and wherein the discharge opening fluidly couples to a discharge body input of the discharge body of the walk-behind power equipment device; a turf guide structure extending from the side portion toward the front portion and defining a front-facing surface having a first edge that extends approximately to a full extent of the side portion; and a second turf guide structure extending from a second side portion, on an opposite side of the mow deck from the side portion, toward the front portion and defining a second front-facing surface having a second edge that extends approximately to a full extent of the second side portion, wherein a distance across the front portion of the mow deck from the first edge to the second edge is approximately equal to a full width of the mow deck.

A twenty-fourth aspect is an optional form of the twenty-third aspect, wherein the second opening defined by the discharge opening has a leading edge proximate the side portion of the mow deck and a trailing edge proximate the rear portion of the mow deck.

A twenty-fifth aspect is an optional form of the twenty-fourth aspect, wherein a full extent of the front portion defines a zero degree position of the mow deck, the full extent of the side portion defines a ninety degree position of the mow deck and a full extent of the rear portion defines a one hundred eighty degree position of the mow deck, and further wherein the leading edge is between the ninety degree position and a one hundred thirty degree position of the mow deck.

A twenty-sixth aspect is an optional form of the twenty-fifth aspect, wherein the leading edge is at about a one hundred ten degree position of the mow deck.

A twenty-seventh aspect is an optional form of the twenty-fifth aspect, wherein the trailing edge is between about a one hundred seventy degree position and about the one hundred eighty degree position.

A twenty-eighth aspect is an optional form of the twenty-fourth aspect, wherein the mow deck comprises an interior perimeter surface on an underside of the mow deck and wherein the interior perimeter surface forward of the leading edge of the second opening defines a substantially elliptical perimeter surface portion and wherein the interior perimeter surface rearward of the leading edge defines a substantially linear perimeter surface portion.

A twenty-ninth aspect is an optional form of the twenty-eighth aspect, wherein the substantially linear perimeter surface portion serves as an interior baffle formed integral with the perimeter surface of the mow deck.

A thirtieth aspect is an optional form of the twenty-eighth aspect, wherein the substantially linear perimeter surface portion ends prior to the trailing edge of the second opening and the interior perimeter surface defines a second substantially elliptical perimeter surface portion from an end of the substantially linear perimeter surface portion to the rear portion of the mow deck.

A thirty-first aspect is an optional form of the thirtieth aspect, wherein a line extending through the front portion of the mow deck and the rear portion of the mow deck defines a discharge side of the mow deck to one side of the line and a non-discharge side of the mow deck to the other side of the line, wherein the interior perimeter surface includes the substantially linear perimeter surface portion defined on the discharge side of the mow deck and a second substantially linear perimeter surface portion defined on the non-discharge side of the mow deck, and wherein the second substantially elliptical perimeter surface portion extends from the end of the substantially linear perimeter surface portion to an end of the second substantially linear perimeter surface portion.

A thirty-second aspect is an optional form of the twenty-third aspect, wherein the rear portion includes a rear side wall, the side portion includes a side wall and the front portion includes a front side wall.

A thirty-third aspect is an optional form of the thirty-second aspect, wherein the rear side wall of the rear portion forms an angle with the ground within a range from about 30 degrees to about 60 degrees.

A thirty-fourth aspect is an optional form of the thirty-third aspect, wherein the side wall of the side portion forms a second angle with the ground within a range from about 170 degrees to about 180 degrees.

A thirty-fifth aspect is an optional form of the thirty-third aspect, wherein the front side wall of the front portion forms a second angle with the ground within the range from about 30 degrees to about 60 degrees.

A thirty-sixth aspect is an optional form of the twenty-third aspect, having a height in a range from 2 inches to 3 inches.

In a thirty-seventh aspect the present subject matter is a grass mowing apparatus, comprising: a plurality of front wheels and a plurality of rear wheels; a mow deck comprising a rear interior surface having an asymmetric length portion or an asymmetric height portion with respect to a centerline of the mow deck; a cutting system comprising a plurality of blades rotatable within an interior of the mow deck in response to a force; an electric motor coupled to the cutting system and configured to supply the force to rotate the plurality of blades; a rechargeable battery for providing electrical power to the electric motor; a discharge opening defined in a side-rear portion of the mow deck, wherein the discharge opening has a leading edge behind a right-most side of the mow deck and a trailing edge near a rear-most side of the mow deck, the right-most side and the rear-most side defined relative to an operator position at a rear of the grass mowing apparatus; a discharge chute body having a discharge chute input fluidly coupled with the discharge opening defined in the mow deck; and a mulching plug configured to fit conformally within the discharge chute input and having a mulching plug interior surface configured to prevent turf clippings from entering the discharge chute body through the discharge opening.

A thirty-eighth aspect is an optional form of the thirty-seventh aspect, wherein the mow deck defines an interior top surface that is asymmetric in height with respect to the centerline of the mow deck.

A thirty-ninth aspect is an optional form of the thirty-eighth aspect, wherein the centerline of the mow deck divides a discharge side of the mow deck from a trim side of the mow deck, and wherein the interior top surface has a first height at the trim side relative to a bottom edge of the mow deck and a second height at the discharge side relative to the bottom edge of the mow deck.

A fortieth aspect is an optional form of the thirty-ninth aspect, wherein the first height defines a minimum height of the interior top surface and the second height defines a maximum height of the interior top surface.

A forty-first aspect is an optional form of the fortieth aspect, wherein the interior top surface increases in height from the first height that defines the minimum height at an inflection point, and wherein the inflection point is located radially about a top surface of the mow deck within a range of radiuses from about a zero degree radius and increasing to about a ninety degree radius, wherein the zero degree radius intersects a front-most edge of the mow deck defined from the operator position and wherein the ninety degree radius intersects a left-most edge of the mow deck defined from the operator position.

A forty-second aspect is an optional form of the forty-first aspect, wherein the inflection point is located at a radius that is about thirty degrees from the zero degree radius, defined from the operator position.

A forty-third aspect is an optional form of the thirty-eighth aspect, wherein the interior top surface defines a first height above a bottom edge of the mow deck in a first region of the interior top surface and defines a second height above the bottom edge in a second region of the interior top surface, and wherein the first height is within a range from about 15 percent to about 95 percent larger than the second height.

A forty-fourth aspect is an optional form of the thirty-eighth aspect, wherein the interior top surface defines a first height above a bottom edge of the mow deck in a first region of the interior top surface and defines a second height above the bottom edge in a second region of the interior top surface, and wherein the second height is within a range from about 2.25 inches to about 2.75 inches from the bottom edge, and wherein the first height is within a second range from about 3 inches to about 5.5 inches from the bottom edge.

A forty-fifth aspect is an optional form of the thirty-seventh aspect, wherein the mulching plug interior surface defines a first flow path for turf clippings and a second flow path for turf clippings that is physically separated from the first flow path by an edge of an input vane.

A forty-sixth aspect is an optional form of the forty-fifth aspect, wherein the first flow path directs turf clippings received upon the mulching plug interior surface at the first flow path onto a discharge side of the rear interior surface.

A forty-seventh aspect is an optional form of the forty-fifth aspect, wherein the second flow path directs turf clippings received upon the mulching plug interior surface at the second flow path onto a trim side of the rear interior surface.

A forty-eighth aspect is an optional form of the thirty-seventh aspect, wherein: the asymmetric length portion of the rear interior surface of the mow deck extends from a discharge side of the rear interior surface to a trim side of the rear interior surface; and the asymmetric length portion defines a minimum distance between the rear interior surface and a blade tip of the plurality of blades at the discharge side and defines a maximum distance between the rear interior surface and the blade tip of the plurality of blades at the trim side.

A forty-ninth aspect is an optional form of the forty-eighth aspect, wherein the minimum distance is within a range from about fifty percent to about ninety percent of the maximum distance.

A fiftieth aspect is an optional form of the forty-eighth aspect, wherein the minimum distance is within a range from about 0.7 inches to about 0.9 inches.

A fifty-first aspect is an optional form of the forty-eighth aspect, wherein the maximum distance is within a range from about 1.0 inches to about 1.2 inches.

A fifty-second aspect is an optional form of the forty-eighth aspect, wherein the minimum distance at the discharge side inhibits ejection of turf clippings from the mow deck to ground below the plurality of blades, and wherein the maximum distance at the trim side promotes ejection of turf clippings from the mow deck to ground.

A fifty-third aspect is an optional form of the thirty-seventh aspect, wherein the rear interior surface comprises both the asymmetric length portion and the asymmetric height portion.

A fifty-fourth aspect is an optional form of the thirty-seventh aspect, wherein the asymmetric height portion defines a forward sloping curvature toward a center of the mow deck as the asymmetric height portion extends from a top to a bottom edge of the rear interior surface near a discharge side of the mow deck and defines a flat surface from the top to the bottom edge of the rear interior surface near a trim side of the mow deck.

A fifty-fifth aspect is an optional form of the fifty-fourth aspect, wherein the forward sloping curvature reduces ejection of turf clippings below the mow deck to ground at the discharge side of the mow deck and wherein the flat surface promotes ejection of turf clippings below the mow deck to ground at the trim side of the mow deck.

A fifty-sixth aspect is an optional form of the thirty-seventh aspect, wherein the rear interior surface of the mow deck defines an edge curvature that reduces ejection of turf clippings from the mow deck at a discharge side of the mow deck and that promotes ejection of turf clippings from the mow deck at a trim side of the mow deck.

A fifty-seventh aspect is an optional form of the fifty-sixth aspect, wherein the mulching plug interior surface comprises a first clipping flow path that directs a first subset of turf clippings to the discharge side of the mow deck and a second clipping flow path that directs a second subset of turf clippings to the trim side of the mow deck.

A fifty-eighth aspect is an optional form of the fifty-seventh aspect, wherein the mulching plug interior surface defines an input vane that divides the first clipping flow path from the second clipping flow path.

A fifty-ninth aspect is an optional form of the fifty-eighth aspect, wherein a vertical distance between the input vane and a cutting edge of an upper blade of the plurality of blades is within a range from about 0.8 inches to about 1.2 inches.

In a sixtieth aspect the present subject matter is a mulching plug for a discharge chute of a walk-behind power equipment device, comprising: an interior surface having a surface edge that fits conformally with a perimeter of a discharge opening in a mow deck of the walk-behind power equipment device; an exterior surface that includes an operator handle, wherein the discharge chute defines an intake opening within the discharge body positioned adjacent to the discharge opening in the mow deck; a discharge extension surface extending from an edge of the exterior surface and that fits conformally with a surface of the discharge chute and has a length dimension approximately equal to a depth of the discharge chute through the discharge body; and a sleeve surface at an opposite end of the bottom surface from the exterior surface that seats upon a back surface of the discharge body and prevents the interior surface of the mulching plug from extending through the discharge opening in the mow deck.

A sixty-first aspect is an optional form of the sixtieth aspect, wherein the interior surface defines a plurality of flow paths that respectively direct turf clippings along separate physical positions within the mow deck.

A sixty-second aspect is an optional form of the sixty-first aspect, wherein the interior surface further defines an input vane edge that separates a first flow path of the plurality of flow paths from a second flow path of the plurality of flow paths and physically separates first turf clippings directed to the first flow path by the input vane edge from second turf clippings directed to the second flow path by the input vane edge.

A sixty-third aspect is an optional form of the sixty-second aspect, wherein the first turf clippings are directed to a lower path distribution that ejects the first turf clippings along a discharge side of a rear wall of the mow deck.

A sixty-fourth aspect is an optional form of the sixty-second aspect, wherein the second turf clippings are directed to an upper path distribution that ejects the second turf clippings along a trim side of a rear wall of the mow deck.

A sixty-fifth aspect is an optional form of the sixty-second aspect, wherein a top edge of the mulching plug slopes downward in height from a frontward edge of the mulching plug that faces a front of the mow deck toward a rearward edge of the mulching plug that faces a rear of the mow deck as positioned conformal to the perimeter of the discharge opening in the mow deck, wherein the downward height of the top edge matches a downward slope of a top surface of the mow deck.

A sixty-sixth aspect is an optional form of the sixty-fifth aspect, wherein the downward height of the top edge of the mulching plug at the rearward edge of the mulching plug and the downward slope of the top surface of the mow deck direct the second turf clippings toward the ground beneath the mow deck and toward the upper path distribution along the trim side of the rear wall of the mow deck.

A sixty-seventh aspect is an optional form of the sixtieth aspect, wherein the operator handle facilitates insertion of the mulching plug within a discharge chute of a discharge body connected to the mow deck and extraction of the mulching plug from the discharge chute.

In a sixty-eighth aspect the present subject matter is a mowing apparatus, comprising: an electric motor having a work output shaft adapted to transmit work to rotate components operationally engaged therewith about a first axis; a rechargeable battery adapted to supply electrical power to the electric motor; a mow deck defining, a deck front and a deck rear offset from the deck front by a deck depth, a deck right and a deck left offset from the deck right by a deck width, a deck top and a deck bottom offset from the top by a deck height, an interior surface surrounding the first axis, and a sagittal plane extending through the first axis between the deck right and deck left, a coronal plane extending through the first axis between the deck front and deck rear; a blade mount operationally engaged with the work output shaft and adapted to be rotated thereby within the interior surface about the first axis in an operational direction; a first elongated blade fixedly engaged with the blade mount, extending away from the first axis along a first blade axis, adapted to rotate simultaneously with the blade mount around the first axis to define a first blade path boundary having a rear half behind the coronal plane, and operable to cut a mowable material to generate clippings; wherein the rear surface has one or more features adapted to modify air flow to increase discharge rate of clippings as distance in the operational direction along the rear half of the first blade path boundary increases.

A sixty-ninth aspect is an optional form of the sixty-eighth aspect, further comprising a second elongated blade fixedly engaged with the blade mount; extending away from the first axis along a second blade axis offset from the first blade axis by an offset angle; adapted to rotate simultaneously with the blade mount around the second axis to define a second blade path boundary; and operable to cut a mowable material to generate clippings.

A seventieth aspect is an optional form of the sixty-ninth aspect, wherein either: a) the rear surface is offset from the first axis by a clearance distance which increases as distance along the rear half of the first blade path boundary in the operational direction increases; or b) the interior surface has a height relative to the deck bottom that continuously increases as distance in the operational direction along the first blade path boundary increases between a minimum height inflection point and a maximum height inflection point.

A seventy-first aspect is an optional form of the sixty-ninth aspect, wherein the offset angle is between 85 and 95 degrees; or wherein the first elongated blade is a lift blade adapted to provide upward force on clippings generated during operation; or wherein the interior surface has a rear-most interior wall that forms a rear intersection with the sagittal plane, and wherein the rear intersection is at angle to a plane normal to the first axis between 30 degrees and 60 degrees; or wherein the interior surface has a front-most interior wall that forms a front intersection with the sagittal plane, and wherein the front intersection is at angle to a plane normal to the first axis between 30 degrees and 60 degrees.

A seventy-second aspect is an optional form of the sixty-ninth aspect, further comprising a discharge opening defined in a side-rear portion of the mow deck, wherein the discharge opening has a leading edge behind a right-most side of the mow deck and a trailing edge near a rear-most side of the mow deck, the right-most side and the rear-most side defined relative to an operator position at a rear of the grass mowing apparatus.

A seventy-third aspect is an optional form of the seventy-second aspect, further comprising a discharge chute body having a discharge chute input fluidly coupled with the discharge opening defined in the mow deck.

A seventy-fourth aspect is an optional form of the seventy-third aspect, further comprising a mulching plug configured to fit conformally within the discharge chute input and having a mulching plug interior surface configured to prevent clippings from entering the discharge chute body through the discharge opening.

A seventy-fifth aspect is an optional form of the seventy-second aspect, further comprising a discharge chute body having a discharge chute input and a discharge chute output, wherein the discharge chute input of the discharge chute body is fluidly coupled with the discharge opening defined in the mow deck such that air and clippings within an interior of the mow deck enter the discharge chute body from the discharge opening and the discharge chute input and exit the discharge chute body through the discharge chute output.

A seventy-sixth aspect is an optional form of the seventieth aspect, wherein the interior surface has a height relative to the deck bottom that continuously increases as distance in the operational direction along the first blade path boundary increases between a minimum height inflection point and a maximum height inflection point.

A seventy-seventh aspect is an optional form of the seventy-sixth aspect, wherein the minimum height inflection point is on a plane passing through the first axis and at an acute first angle to the coronal plane as measured in the operational direction; and wherein the first angle is about 30 degrees.

A seventy-eighth aspect is an optional form of the seventy-sixth aspect, wherein the height at the maximum height inflection point is between 15% and 95% greater than the height at the minimum height inflection point; or wherein the height at the maximum height inflection point is between 3 inches and 5.5 inches and the height at the minimum height inflection point is between 2.25 inches and 2.75 inches.

A seventy-ninth aspect is an optional form of the seventy-fourth aspect, wherein the mulching plug interior surface defines a first flow path for clippings and a second flow path for clippings that is physically separated from the first flow path by an edge of an input vane; and wherein the first flow path directs clippings to a discharge side of the rear surface, and the second flow path directs clippings onto a trim side of the rear surface.

In an eightieth aspect the present subject matter is a mulching plug for a discharge chute of a walk-behind power equipment device, comprising: an interior surface having a surface edge that fits conformally with a perimeter of a discharge opening in a mow deck of the walk-behind power equipment device; an exterior surface that includes an operator handle, wherein the discharge chute defines an intake opening within the discharge body positioned adjacent to the discharge opening in the mow deck; a discharge extension surface extending from an edge of the exterior surface and that fits conformally with a surface of the discharge chute and has a length dimension approximately equal to a depth of the discharge chute through the discharge body; and a sleeve surface at an opposite end of the bottom surface from the exterior surface that seats upon a back surface of the discharge body and prevents the interior surface of the mulching plug from extending through the discharge opening in the mow deck.

An eighty-first aspect is an optional form of the eightieth aspect, wherein the interior surface defines a plurality of flow paths that respectively direct turf clippings along separate physical positions within the mow deck.

An eighty-second aspect is an optional form of the eighty-first aspect, wherein the interior surface further defines an input vane edge that separates a first flow path of the plurality of flow paths from a second flow path of the plurality of flow paths and physically separates first turf clippings directed to the first flow path by the input vane edge from second turf clippings directed to the second flow path by the input vane edge.

An eighty-third aspect is an optional form of the eighty-second aspect, wherein the first turf clippings are directed to a lower path distribution that ejects the first turf clippings along a discharge side of a rear wall of the mow deck; or wherein the second turf clippings are directed to an upper path distribution that ejects the second turf clippings along a trim side of a rear wall of the mow deck; or wherein a top edge of the mulching plug slopes downward in height from a frontward edge of the mulching plug that faces a front of the mow deck toward a rearward edge of the mulching plug that faces a rear of the mow deck as positioned conformal to the perimeter of the discharge opening in the mow deck, wherein the downward height of the top edge matches a downward slope of a top surface of the mow deck.

In an eighty-fourth aspect the present subject matter is a mow deck for a walk-behind power equipment device, comprising: a front portion, a rear portion and a side portion of the mow deck; a plurality of frame mounts at the rear portion of the mow deck for securing the mow deck to a frame and to a discharge body of a walk-behind power equipment device; a center portion defining an opening through a surface of the mow deck and having a seat to support a blade apparatus and an electric motor and one or more mounts to secure the blade apparatus and the electric motor to the mow deck; a discharge opening defining a second opening through the surface of the mow deck near a perimeter of the mow deck and between the rear portion and the side portion and wherein the discharge opening fluidly couples to a discharge body input of the discharge body of the walk-behind power equipment device; a turf guide structure extending from the side portion toward the front portion and defining a front-facing surface having a first edge that extends approximately to a full extent of the side portion; and a second turf guide structure extending from a second side portion, on an opposite side of the mow deck from the side portion, toward the front portion and defining a second front-facing surface having a second edge that extends approximately to a full extent of the second side portion, wherein a distance across the front portion of the mow deck from the first edge to the second edge is approximately equal to a full width of the mow deck.

An eighty-fifth aspect is an optional form of the eighty-fourth aspect, wherein the second opening defined by the discharge opening has a leading edge proximate the side portion of the mow deck and a trailing edge proximate the rear portion of the mow deck.

An eighty-sixth aspect is an optional form of the eighty-fifth aspect, wherein a full extent of the front portion defines a zero degree position of the mow deck, the full extent of the side portion defines a ninety degree position of the mow deck and a full extent of the rear portion defines a one hundred eighty degree position of the mow deck, and further wherein the leading edge is between the ninety degree position and a one hundred thirty degree position of the mow deck.

An eighty-seventh aspect is an optional form of the eighty-fifth aspect, wherein the mow deck comprises an interior perimeter surface on an underside of the mow deck and wherein the interior perimeter surface forward of the leading edge of the second opening defines a substantially elliptical perimeter surface portion and wherein the interior perimeter surface rearward of the leading edge defines a substantially linear perimeter surface portion.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A mowing apparatus, comprising:
an electric motor having a work output shaft adapted to transmit work to rotate components operationally engaged therewith about a first axis;
a rechargeable battery adapted to supply electrical power to the electric motor;
a mow deck defining,
a deck front and a deck rear offset from the deck front by a deck depth,
a deck right and a deck left offset from the deck right by a deck width,
a deck top and a deck bottom offset from the top by a deck height,
an interior surface surrounding the first axis, and
a sagittal plane extending through the first axis between the deck right and deck left,
a coronal plane extending through the first axis between the deck front and deck rear;
a blade mount operationally engaged with the work output shaft and adapted to be rotated thereby within the interior surface about the first axis in an operational direction;
a first elongated blade
fixedly engaged with the blade mount,
extending away from the first axis along a first blade axis,
adapted to rotate simultaneously with the blade mount around the first axis to define a first blade path boundary having a rear half behind the coronal plane, and
operable to cut a mowable material to generate clippings;
wherein the rear surface has one or more features adapted to modify air flow to increase discharge rate of clippings as distance in the operational direction along the rear half of the first blade path boundary increases.

2. The mowing apparatus of claim 1, further comprising a second elongated blade
fixedly engaged with the blade mount;
extending away from the first axis along a second blade axis offset from the first blade axis by an offset angle;
adapted to rotate simultaneously with the blade mount around the second axis to define a second blade path boundary; and
operable to cut a mowable material to generate clippings.

3. The mowing apparatus of claim 2, wherein
a) the rear surface is offset from the first axis by a clearance distance which increases as distance along the rear half of the first blade path boundary in the operational direction increases; or
b) the interior surface has a height relative to the deck bottom that continuously increases as distance in the operational direction along the first blade path boundary increases between a minimum height inflection point and a maximum height inflection point.

4. The mowing apparatus of claim 2, wherein
the offset angle is between 85 and 95 degrees; or
wherein the first elongated blade is a lift blade adapted to provide upward force on clippings generated during operation; or
wherein the interior surface has a rear-most interior wall that forms a rear intersection with the sagittal plane, and wherein the rear intersection is at angle to a plane normal to the first axis between 30 degrees and 60 degrees; or
wherein the interior surface has a front-most interior wall that forms a front intersection with the sagittal plane, and wherein the front intersection is at angle to a plane normal to the first axis between 30 degrees and 60 degrees.

5. The mowing apparatus of claim 2, further comprising a discharge opening defined in a side-rear portion of the mow deck, wherein the discharge opening has a leading edge behind a right-most side of the mow deck and a trailing edge near a rear-most side of the mow deck, the right-most side and the rear-most side defined relative to an operator position at a rear of the grass mowing apparatus.

6. The mowing apparatus of claim 5, further comprising a discharge chute body having a discharge chute input fluidly coupled with the discharge opening defined in the mow deck.

7. The mowing apparatus of claim 6, further comprising a mulching plug configured to fit conformally within the discharge chute input and having a mulching plug interior surface configured to prevent clippings from entering the discharge chute body through the discharge opening.

8. The mowing apparatus of claim 5, further comprising a discharge chute body having a discharge chute input and a discharge chute output, wherein the discharge chute input of the discharge chute body is fluidly coupled with the discharge opening defined in the mow deck such that air and clippings within an interior of the mow deck enter the discharge chute body from the discharge opening and the discharge chute input and exit the discharge chute body through the discharge chute output.

9. The mowing apparatus of claim 3, wherein the interior surface has a height relative to the deck bottom that continuously increases as distance in the operational direction along the first blade path boundary increases between a minimum height inflection point and a maximum height inflection point.

10. The mowing apparatus of claim 9, wherein the minimum height inflection point is on a plane passing through the first axis and at an acute first angle to the coronal plane as measured in the operational direction; and wherein the first angle is about 30 degrees.

11. The mowing apparatus of claim 9, wherein
the height at the maximum height inflection point is between 15% and 95% greater than the height at the minimum height inflection point; or
wherein the height at the maximum height inflection point is between 3 inches and 5.5 inches and the height at the minimum height inflection point is between 2.25 inches and 2.75 inches.

12. The mowing apparatus of claim 7,
wherein the mulching plug interior surface defines a first flow path for clippings and a second flow path for clippings that is physically separated from the first flow path by an edge of an input vane; and
wherein the first flow path directs clippings to a discharge side of the rear surface, and the second flow path directs clippings onto a trim side of the rear surface.

13. A mulching plug for a discharge chute of a walk-behind power equipment device, comprising:
an interior surface having a surface edge that fits conformally with a perimeter of a discharge opening in a mow deck of the walk-behind power equipment device;
an exterior surface that includes an operator handle, wherein the discharge chute defines an intake opening within the discharge body positioned adjacent to the discharge opening in the mow deck;
a discharge extension surface extending from an edge of the exterior surface and that fits conformally with a surface of the discharge chute and has a length dimension approximately equal to a depth of the discharge chute through the discharge body; and
a sleeve surface at an opposite end of the bottom surface from the exterior surface that seats upon a back surface of the discharge body and prevents the interior surface of the mulching plug from extending through the discharge opening in the mow deck.

14. The mulching plug of claim 13, wherein the interior surface defines a plurality of flow paths that respectively direct turf clippings along separate physical positions within the mow deck.

15. The mulching plug of claim 14, wherein the interior surface further defines an input vane edge that separates a first flow path of the plurality of flow paths from a second flow path of the plurality of flow paths and physically separates first turf clippings directed to the first flow path by the input vane edge from second turf clippings directed to the second flow path by the input vane edge.

16. The mulching plug of claim 15,
wherein the first turf clippings are directed to a lower path distribution that ejects the first turf clippings along a discharge side of a rear wall of the mow deck; or
wherein the second turf clippings are directed to an upper path distribution that ejects the second turf clippings along a trim side of a rear wall of the mow deck; or
wherein a top edge of the mulching plug slopes downward in height from a frontward edge of the mulching plug that faces a front of the mow deck toward a rearward edge of the mulching plug that faces a rear of the mow deck as positioned conformal to the perimeter of the discharge opening in the mow deck, wherein the downward height of the top edge matches a downward slope of a top surface of the mow deck.

17. A mow deck for a walk-behind power equipment device, comprising:
a front portion, a rear portion and a side portion of the mow deck;
a plurality of frame mounts at the rear portion of the mow deck for securing the mow deck to a frame and to a discharge body of a walk-behind power equipment device;
a center portion defining an opening through a surface of the mow deck and having a seat to support a blade apparatus and an electric motor and one or more mounts to secure the blade apparatus and the electric motor to the mow deck;
a discharge opening defining a second opening through the surface of the mow deck near a perimeter of the mow deck and between the rear portion and the side portion and wherein the discharge opening fluidly couples to a discharge body input of the discharge body of the walk-behind power equipment device;
a turf guide structure extending from the side portion toward the front portion and defining a front-facing surface having a first edge that extends approximately to a full extent of the side portion; and
a second turf guide structure extending from a second side portion, on an opposite side of the mow deck from the side portion, toward the front portion and defining a second front-facing surface having a second edge that extends approximately to a full extent of the second side portion, wherein a distance across the front portion of the mow deck from the first edge to the second edge is approximately equal to a full width of the mow deck.

18. The mow deck of claim 17, wherein the second opening defined by the discharge opening has a leading edge proximate the side portion of the mow deck and a trailing edge proximate the rear portion of the mow deck.

19. The mow deck of claim 18, wherein a full extent of the front portion defines a zero degree position of the mow deck, the full extent of the side portion defines a ninety degree position of the mow deck and a full extent of the rear portion defines a one hundred eighty degree position of the mow deck, and further wherein the leading edge is between the ninety degree position and a one hundred thirty degree position of the mow deck.

20. The mow deck of claim 18, wherein the mow deck comprises an interior perimeter surface on an underside of the mow deck and wherein the interior perimeter surface forward of the leading edge of the second opening defines a substantially elliptical perimeter surface portion and wherein the interior perimeter surface rearward of the leading edge defines a substantially linear perimeter surface portion.
